(19) United States
(12) Patent Application Publication
(10) Pub. No.: US 2026/0112749 A1
(43) Pub. Date: Apr. 23, 2026

(54) ENERGY STORAGE DEVICE

(71) Applicant: GS Yuasa International Ltd., Kyoto (JP)

(72) Inventors: Kazuya OKABE, Kyoto (JP); Ryoichi OKUYAMA, Kyoto (JP); Yoshihito TAKAGI, Kyoto (JP); Hironori AIDA, Kyoto (JP)

(73) Assignee: GS Yuasa International Ltd., Kyoto (JP)

(21) Appl. No.: 18/695,352

(22) PCT Filed: Oct. 12, 2022
(86) PCT No.: PCT/JP2022/037954

§ 371 Date: Mar. 25, 2024

(30) Foreign Application Priority Data
Oct. 13, 2021 (JP) 2021-167979
Oct. 13, 2021 (JP) 2021-167991
Oct. 13, 2021 (JP) 2021-168402

(51) Int. Cl. H01M 50/176; H01M 10/04; H01M 50/103; H01M 50/538; H01M 50/548; H01M 50/557; H01M 50/564

(52) U.S. Cl. CPC H01M 50/176; H01M 10/0431; H01M 50/103; H01M 50/538; H01M 50/548; H01M 50/557; H01M 50/564

(57) ABSTRACT

An energy storage device includes: an electrode assembly formed by stacking a plurality of plates and elongated in a predetermined direction intersecting with a stacking direction; a container that accommodates the electrode assembly and is elongated in the predetermined direction; and a positive electrode terminal and a negative electrode terminal that are electrically connected to the electrode assembly. The electrode assembly includes: an electrode assembly body; and a pair of connecting portions that protrudes from one end portion of the electrode assembly body in the predetermined direction, and is electrically connected to the positive electrode terminal and the negative electrode terminal. A protruding portion on which the pair of connecting portions is disposed is formed at one end portion of the container in the predetermined direction.

### TECHNICAL FIELD

The present invention relates to an energy storage device that includes an electrode assembly.

### BACKGROUND ART

Conventionally, there has been known an energy storage device in which a pair of terminals (a negative electrode output terminal and a positive electrode terminal) is mounted on a lid body (lid) of a container which accommodates an electrode assembly in a state where the pair of terminals protrudes (see, for example, Patent Document 1).

### PRIOR ART DOCUMENT

### Patent Document

Patent Document 1: JP-A-2010-73580

### SUMMARY OF THE INVENTION

### Problems to be Solved by the Invention

In recent years, there has been a demand for the increase of energy density of an energy storage device.

It is an object of the present invention to increase energy density of an energy storage device.

### Means for Solving the Problems

To achieve the above-mentioned object, according to one aspect of the present invention, there is provided an energy storage device that includes: an electrode assembly that is formed by stacking a plate and is elongated in a predetermined direction intersecting with a stacking direction; a container that accommodates the electrode assembly and is elongated in the predetermined direction; and a positive electrode terminal and a negative electrode terminal that are electrically connected to the electrode assembly, in which the electrode assembly includes: an electrode assembly body; and a pair of connecting portions that protrudes from one end portion of the electrode assembly body in the winding axis direction, and is electrically connected to the positive electrode terminal and the negative electrode terminal, and a protruding portion on which the pair of connecting portions is disposed is formed at one end portion of the container in the winding axis direction.

### Advantages of the Invention

According to the energy storage device of the present invention, it is possible to increase the energy density of the energy storage device.

### BRIEF DESCRIPTION OF THE DRAWINGS

FIG. 1 is a perspective view illustrating an external appearance of an energy storage device according to an embodiment 1.

FIG. 2 is an exploded perspective view of the energy storage device according to the embodiment 1 illustrating respective constitutional elements in a state where the energy storage device is disassembled.

FIG. 3 is a perspective view illustrating the configuration of an electrode assembly according to the embodiment 1.

FIG. 4 is a plan view illustrating a first side surface portion according to the embodiment 1.

FIG. 5 is a plan view schematically illustrating an energy storage device according to a comparative example.

FIG. 6 is an explanatory view illustrating a state where a voltage measurement wire is mounted on a second recessed portion according to the embodiment 1.

FIG. 7 is a plan view illustrating a first side surface portion according a modification 1 of the embodiment 1.

FIG. 8 is a top plan view illustrating a first side surface portion according to a modification 2 of the embodiment 1.

FIG. 9 is an explanatory view illustrating rough positions of the first side surface portion, a second side surface portion, a first recessed portion, and the second recessed portion according to the embodiment 1.

FIG. 10 is a perspective view illustrating an external appearance of an energy storage device according to an embodiment 2.

FIG. 11 is an exploded perspective view of the energy storage device according to the embodiment 2 illustrating respective constitutional elements in a state where the energy storage device is disassembled.

FIG. 12 is a perspective view illustrating the configuration of an electrode assembly according to the embodiment 2.

FIG. 13 is a plan view illustrating a first side surface portion according to the embodiment 2.

FIG. 14 is a plan view schematically illustrating an energy storage device according to a comparative example.

FIG. 15 is a plan view illustrating a first side surface portion according a modification 1 of the embodiment 2.

FIG. 16 is a plan view illustrating a first side surface portion according a modification 2 of the embodiment 2.

FIG. 17 is a top plan view illustrating the first side surface portion according to the modification 2 of the embodiment 2.

FIG. 18 is an explanatory view illustrating rough positions of the first side surface portion, a second side surface portion, and recessed portions according to the embodiment 2.

FIG. 19 is a schematic plan view illustrating an energy storage device according to an embodiment 3.

FIG. 20 is a schematic plan view illustrating an energy storage device according to a modification 1 of the embodiment 3.

FIG. 21 is a schematic plan view illustrating an energy storage device according to a modification 2 of the embodiment 3.

### MODE FOR CARRYING OUT THE INVENTION

(1) An energy storage device according to one aspect of the present invention includes: an electrode assembly that is formed by stacking a plurality of plates and is elongated in a predetermined direction intersecting with a stacking direction; a container that accommodates the electrode assembly and is elongated in the predetermined direction; and a positive electrode terminal and a negative electrode terminal that are electrically connected to the electrode assembly, in which the electrode assembly includes: an electrode assembly body; and a pair of connecting portions that protrudes from one end portion of the electrode assembly body in the predetermined direction, and is electrically connected to the positive electrode terminal and the negative electrode terminal, and a protruding portion on which the pair of connecting portions is disposed is formed at one end portion of the container in the predetermined direction.

According to the above-mentioned configuration, the pair of connecting portions of the electrode assembly is disposed in the protruding portion of the container and hence, a space used for accommodating the pair of connecting portions in the container can be collectively disposed in the protruding portion. With such a configuration, the space other than the protruding portion in the container is minimally used for the pair of connecting portions. Accordingly, the electrode assembly body can be large-sized in the space other than the protruding portion in the container. As a result, it is possible to increase the energy density.

(2) In the energy storage device according to the above-mentioned (1), an other end portion of the container in the predetermined direction may be formed in a flat shape.

In this embodiment, with respect to the container, to compare the configuration where the protruding portion is formed on both end portions of the container in the predetermined direction and the configuration where the protruding portion is formed on one end portion and the other end portion is formed in a flat shape, assuming that both configurations have the same length in the predetermined direction, the latter configuration can make the space other than the protruding portion larger. That is, in a case where the container is formed such that the protruding portion is formed on one end portion of the container and the other end portion of the container is formed in a flat shape, an electrode assembly body can be made larger. Accordingly, it is possible to increase the energy density.

(3) In the energy storage device according to the above-mentioned (1) or (2), a pair of recessed portions that interposes the protruding portion may be formed on the one end portion of the container, the positive electrode terminal may be disposed in one recessed portion out of the pair of recessed portions, and the negative electrode terminal may be disposed in an other recessed portion out of the pair of recessed portions.

With such a configuration, the positive electrode terminal and the negative electrode terminal are disposed in the pair of recessed portions that interposes the protruding portion therebetween and hence, a protruding amount of each terminal from the container can be suppressed. Accordingly, it is possible to reduce an energy storage device accommodating space outside the container attributed to respective terminals.

(4) In the energy storage device according to the above-mentioned (3), the protruding portion may include a pair of terminal mounting surfaces that opposedly faces each other in an arrangement direction of the pair of connecting portions, the positive electrode terminal may be disposed on one terminal mounting surface out of the pair of terminal mounting surfaces, and the negative electrode terminal may be disposed on an other terminal mounting surface out of the pair of terminal mounting surface.

With such a configuration, the pair of terminal mounting surfaces opposedly face each other in the arrangement direction of the pair of connecting portions and hence, one terminal disposing surface and the positive electrode terminal can be disposed close to each other, and the other terminal mounting surface and the negative electrode terminal can be disposed close to each other. Accordingly, the electrical connection structure between the respective terminals and the respective connecting portions can be accommodated in the protruding portion. That is, it is possible to suppress the electrical connection structure from using a space other than the protruding portion and hence, the electrode assembly body can be made larger. Accordingly, it is possible to increase the energy density.

(5) In the energy storage device according to the above-mentioned (1), the electrode assembly may include a pair of an other connecting portions that protrudes from an other end portion in the predetermined direction and is electrically connected to an other positive electrode terminal and an other negative electrode terminal, and an other protruding portion on which the pair of the other connecting portions is disposed may be formed on an other end portion of the container in the predetermined direction.

With such a configuration, the other protruding portion where the pair of the other connecting portions is disposed is also formed at the other end portion of the container. Accordingly, also in the energy storage device that includes the electrode assembly where the pair of connecting portions protrudes from both end portions of the container respectively and hence, the electrode assembly body can be large-sized.

(6) In the energy storage device according to any one of the above-mentioned (1) to (5), the electrode assembly is configured such that the plurality of plates are wound using the predetermined direction as a winding axis direction.

With such a configuration, also in the winding-type electrode assembly, the electrode assembly body can be large-sized in a space other than the protruding portion in the container. Accordingly, it is possible to increase the energy density of the energy storage device that uses the winding-type electrode assembly.

### EMBODIMENTS

Hereinafter, energy storage devices according to the embodiments (including modifications of the embodiments) of the present invention are described with reference to the drawings. All embodiments described hereinafter are comprehensive examples or specific examples of the present invention. Numerical values, shapes, materials, constitutional elements, arrangement positions and connection modes of the constitutional elements, manufacturing steps, the order of the manufacturing steps, and the like in the following exemplary embodiment are provided as examples, and are not intended to limit the present invention. In the respective drawings, sizes and the like are not strictly illustrated. In the respective drawings, identical or substantially identical constitutional elements are given the same symbols.

In the following description and drawings, a direction extending along a winding axis of an electrode assembly, a direction along which the electrode assembly extends, or a direction that short-side surfaces of a container face each other is defined as an X-axis direction. A direction along which long-side surfaces of the container face each other or a thickness direction of the container is defined as a Y-axis direction. A direction along which a bottom surface of a container body of the container and a top surface of a lid body are arranged or a vertical direction is defined as a Z-axis direction. The X-axis direction is an example of a first direction and a predetermined direction, and the Z-axis direction is an example of a second direction. These X-axis direction, Y-axis direction, and Z-axis direction are the directions that intersect with each other (orthogonal to each other in the present embodiments). There may be a case where the Z-axis direction is not equal to the vertical direction depending on a use mode. However, in the description made hereinafter, for the sake of convenience of the description, the description is made by assuming the Z-axis direction as the vertical direction.

In the description made hereinafter, an X-axis positive direction indicates an arrow direction of an X-axis, and an X-axis negative direction indicates a direction opposite to the X-axis positive direction. The same goes for the Y-axis direction and the Z-axis direction. Expressions indicating the relative directions or the relative postures such as “parallel” or “orthogonal” also include cases where such directions or postures are not taken in a strict meaning of the terms. For example, a state where two directions are orthogonal to each other means not only a state where these two directions are completely orthogonal to each other but also a state where these two directions are substantially orthogonal to each other, that is, for example, a state where these two directions are orthogonal to each other with slight deviation of approximately several percent.

### Embodiment 1

### [Description of Overall Configuration of Energy Storage Device]

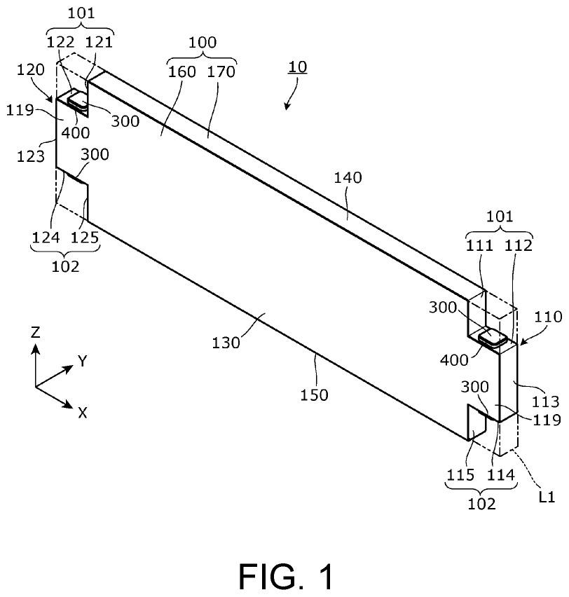

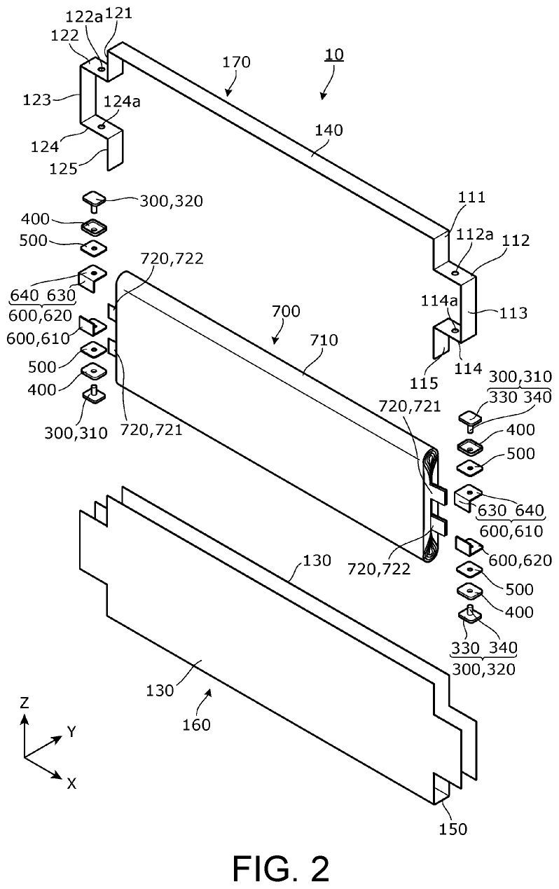

First, the overall configuration of an energy storage device 10 according to an embodiment 1 will be described with reference to FIG. 1 and FIG. 2. FIG. 1 is a perspective view illustrating an external appearance of the energy storage device 10 according to the embodiment 1. FIG. 2 is an exploded perspective view of the energy storage device 10 according to the embodiment 1 illustrating respective constitutional elements in a state where the energy storage device 10 is disassembled.

The energy storage device 10 is an energy storage device into which electricity can be charged from the outside and from which electricity can be discharged to the outside. In this embodiment, the energy storage device 10 has an approximately rectangular parallelepiped shape. For example, the energy storage device 10 is a battery used in an electricity storage application, a power source application, or the like. Specifically, the energy storage device 10 is used as a battery or the like for driving a mobile body such as an automobile, a motorcycle, a watercraft, a ship, a snowmobile, an agriculture machine, a construction machine, or a railway vehicle for an electric railway, or is used as a battery for starting an engine of the mobile body. As the above-described automobile, an electric vehicle (EV), a hybrid electric vehicle (HEV), a plug-in hybrid electric vehicle (PHEV), and an automobile that uses a fossils fuel (a gasoline, a light oil, a liquefied natural gas or the like) are exemplified. As an example of the railway vehicle for the electric railway described above, a train, a monorail, a linear motor car, and a hybrid train including both a diesel engine and an electric motor are exemplified. The energy storage device 10 can also be used as a stationary battery or the like used as a home-use battery, a business-use battery, or the like.

The energy storage device 10 is not limited to a non-aqueous electrolyte secondary battery. The energy storage device 10 may be a secondary battery other than the non-aqueous electrolyte secondary battery, or may be a capacitor. The energy storage device 10 may not be a secondary battery, and may be a primary battery. Further, the energy storage device 10 may be a battery that uses a solid electrolyte. The energy storage device 10 may be a pouch-type energy storage device. In the present embodiment, the energy storage device 10 that has a flat rectangular parallelepiped shape (substantially rectangular parallelepiped shape) as a reference is illustrated. However, the shape of the energy storage device 10, that is, the shape of a container 100 is not limited to a shape that uses a rectangular parallelepiped shape as the reference, and may be a shape using a polygonal columnar shape other than a rectangular parallelepiped shape, an elongated circular columnar shape, an elliptical columnar shape, a circular columnar shape, or the like as the reference.

As illustrated in FIG. 1 and FIG. 2, the energy storage device 10 includes: a container 100; two pairs of electrode terminals 300, and two pairs of outer gaskets 400. Two pairs of inner gaskets 500, two pairs of current collectors 600, and an electrode assembly 700 are accommodated in the container 100. Specifically, the respective members (a pair of electrode terminals 300, a pair of outer gaskets 400, a pair of inner gaskets 500, a pair of current collectors 600, and the like, the same understanding being adopted in the description made hereinafter) of the pair of electrodes (the positive electrode and the negative electrode) are disposed at one end portion of the container 100 in the X-axis positive direction. And the respective members of the remaining pair of electrodes (the positive electrode and the negative electrode) are disposed at the other end portion of the container 100 in the X-axis negative direction. Specifically, on a first side surface portion 110 of the container 100 in the X-axis positive direction, the respective members of the positive electrode are disposed in the Z-axis positive direction, and the respective members of the negative electrode are disposed in the Z-axis negative direction. That is, the first side surface portion 110 is a range where the respective members of the positive electrode and the negative electrode in the X-axis positive direction are arranged from an end surface of the container 100 in the X-axis positive direction. For example, the first side surface portion 110 is a portion within a range of 1% to 10% of the length of the container 100 from the end surface of the container 100 in the X-axis positive direction with respect to the X-axis direction.

On a second side surface portion 120 of the container 100 in the X-axis negative direction, the respective members of the negative electrode are disposed in the Z-axis positive direction, and the respective members of the positive electrode are disposed in the Z-axis negative direction. That is, the second side surface portion 120 is a range where the respective members of the positive electrode and the negative electrode in the X-axis negative direction are arranged from an end surface of the container 100 in the X-axis negative direction. For example, the second side surface portion 120 is a portion within a range of 1% to 10% of the length of the container 100 from the end surface of the container 100 in the X-axis negative direction with respect to the X-axis direction.

With respect to the first side surface portion 110 and the second side surface portion 120 of the container 100, the respective members of the positive electrode and the respective members of the negative electrode are disposed in an inverted manner (in a vertically upside down manner) as viewed from a direction along the winding axis (as viewed in the X-axis direction).

Although an electrolytic solution (a non-aqueous electrolyte) is sealed in the container 100, the illustration of the electrolytic solution is omitted. A kind of the electrolyte solution is not particularly limited provided that the performance of the energy storage device 10 is not impaired, and the electrolyte solution can be selected from various kinds of electrolyte solutions. Besides the constitutional elements described above, the energy storage device 10 may further include spacers disposed on the sides of the electrode assembly 700 or above and below the electrode assembly 700, an insulating film that wraps the electrode assembly 700 and the like.

The container 100 is a case having a profile (substantially rectangular parallelepiped shape) using a flat rectangular parallelepiped shape that is elongated in the X-axis direction as the reference. For example, a length of the container 100 in the X-axis direction is set 3 times or more as long as a length of the container 100 in the Z-axis direction. In FIG. 1, the rectangular parallelepiped shape that is used as the reference is indicated by a double-dashed chain line L1. Specifically, the container 100 has a profile where a rectangular cutout is formed on upper and lower portions of both end portions in the X-axis direction with respect to a flat rectangular parallelepiped shape elongated in the X-axis direction. It can also be said that each cutout forms a recessed portion as viewed in consideration of the rectangular parallelepiped shape used as the reference. With respect to the plurality of cutouts, the pair of cutouts positioned at the upper portion of the container 100 each forms a first recessed portion 101, and the pair of cutouts located at the lower portion of the container 100 each forms a second recessed portion 102. That is, on each of the first side surface portion 110 and the second side surface portion 120 of the container 100, the first recessed portion 101 and the second recessed portion 102 are formed at positions different from each other in the Z-axis direction so as to face each other in the Z-axis direction. An electrode terminal 300 is disposed at each of the first recessed portion 101 and the second recessed portion 102. Accordingly, in each of the first side surface portion 110 and the second side surface portion 120 of the container 100, (the entirety of) the electrode terminal 300 in the first recessed portion 101 and (the entirety of) the electrode terminal 300 in the second recessed portion 102 face each other in the Z-axis direction, and (the entirety of) the electrode terminal 300 in the second recessed portion 102 and (the entirety of) the electrode terminal 300 in the first recessed portion 101 face each other in the Z-axis direction.

FIG. 9 is an explanatory view illustrating rough positions of the first side surface portion 110, the second side surface portion 120, the first recessed portions 101, and the second recessed portions 102 according to the embodiment 1. In FIG. 9, the first side surface portion 110 and the second side surface portion 120 are surrounded by a broken line, and the first recessed portions 101 and the second recessed portions 102 are surrounded by a dotted chain line.

As illustrated in FIG. 1 and FIG. 2, specifically, the first side surface portion 110 includes a first upper side surface 111, a first upper surface 112, a first intermediate side surface 113, a first lower surface 114, and a first lower side surface 115, and the first side surface portion 110 is elongated in the Z-axis direction as viewed in the X-axis direction. The first upper side surface 111 is disposed at an upper portion of the first side surface portion 110, and is a rectangular flat surface that is parallel to a YZ plane and is elongated in the Z-axis direction. The first upper surface 112 is a flat surface extending in the X-axis positive direction from a lower end of the first upper side surface 111, and is a rectangular flat surface that is parallel to the XY plane and is elongated in the X-axis direction. The first intermediate side surface 113 is a flat surface extending downward from an end portion of the first upper surface 112 in the X-axis positive direction, and is a rectangular flat surface that is parallel to the YZ plane and is elongated in the Z-axis direction. The first lower surface 114 is a flat surface extending in the X-axis negative direction from a lower end of the first intermediate side surface 113, and is a rectangular flat surface parallel to the XY plane and elongated in the X-axis direction. The first lower side surface 115 is a flat surface extending downward from an end portion of the first lower surface 114 in the X-axis negative direction, and is a rectangular flat surface that is parallel to the YZ plane and is elongated in the Z-axis direction.

The first recessed portion 101 of the first side surface portion 110 is formed by the first upper side surface 111 and the first upper surface 112, and an end portion of the first recessed portion 101 in the Z-axis positive direction and an end portion of the first recessed portion 101 in the X-axis positive direction are opened. The second recessed portion 102 of the first side surface portion 110 is formed by the first lower surface 114 and the first lower side surface 115, and an end portion of the second recessed portion 102 in the Z-axis negative direction and an end portion of the second recessed portion 102 in the X-axis positive direction are opened. Accordingly, the end portion of the first side surface portion 110 in the Z-axis positive direction (a corner portion of the container 100 in the X-axis positive direction and in the Z-axis positive direction) is formed in a shape where surfaces extending in the X-axis direction and the Z-axis direction are recessed and the shape penetrates in the Y-axis direction. On the other hand, also the end portion of the first side surface portion 110 in the Z-axis negative direction (a corner portion of the container 100 in the X-axis positive direction and in the Z-axis negative direction) is formed in a shape where surfaces extending in the X-axis direction and the Z-axis direction are recessed and the shape penetrates in the Y-axis direction. In other words, the first recessed portion 101 of the first side surface portion 110 is a recessed portion where a corner portion of the container 100 in the X-axis positive direction and in the Z-axis positive direction is recessed (cut out) in a quadrangular shape (L shape) as viewed in the Y-axis direction. The second recessed portion 102 of the first side surface portion 110 is a recessed portion where a corner portion of the container 100 in the X-axis positive direction and in the Z-axis negative direction is recessed (cut out) in a quadrangular shape (L shape) as viewed in the Y-axis direction. On the first side surface portion 110, a portion interposed between the first recessed portion 101 and the second recessed portion 102 in the Z-axis direction is a protruding portion 119. The protruding portion 119 of the first side surface portion 110 is a portion protruding more in the X-axis positive direction than the first upper side surface 111 and the first lower side surface 115.

The second side surface portion 120 includes a second upper side surface 121, a second upper surface 122, a second intermediate side surface 123, a second lower surface 124, and a second lower side surface 125, and the second side surface portion 120 is elongated in the Z-axis direction as viewed in the X-axis direction. The second upper side surface 121 is disposed at an upper portion of the second side surface portion 120, and the second upper side surface 121 is a rectangular flat surface that is parallel to the YZ plane and is elongated in the Z-axis direction. The second upper surface 122 is a flat surface extending in the X-axis negative direction from a lower end of the second upper side surface 121, and the second upper surface 122 is a rectangular flat surface that is parallel to the XY plane and is elongated in the X-axis direction. The second intermediate side surface 123 is a flat surface extending downward from an end portion of the second upper surface 122 in the X-axis negative direction, and the second intermediate side surface 123 is a rectangular flat surface that is parallel to the YZ plane and is elongated in the Z-axis direction. The second lower surface 124 is a flat surface extending in the X-axis positive direction from a lower end of the second intermediate side surface 123, and the second lower surface 124 is a rectangular flat surface that is parallel to the XY plane and is elongated in the X-axis direction. The second lower side surface 125 is a flat surface extending downward from an end portion of the second lower surface 124 in the X-axis negative direction, and the second lower side surface 125 is a rectangular flat surface that is parallel to the YZ plane and is elongated in the Z-axis direction.

The first recessed portion 101 of the second side surface portion 120 is formed by the second upper side surface 121 and the second upper surface 122, and an end portion of the first recessed portion 101 in the Z-axis positive direction and an end portion of the first recessed portion 101 in the X-axis negative direction are opened. The second recessed portion 102 of the second side surface portion 120 is formed by the second lower surface 124 and the second lower side surface 125, and an end portion of the second recessed portion 102 in the Z-axis negative direction and an end portion of the second recessed portion 102 in the X-axis negative direction are opened. Accordingly, the end portion of the second side surface portion 120 in the Z-axis positive direction (a corner portion of the container 100 in the X-axis negative direction and in the Z-axis positive direction) is formed in a shape where surfaces extending in the X-axis direction and the Z-axis direction are recessed and the shape penetrates in the Y-axis direction. On the other hand, the end portion of the second side surface portion 120 in the Z-axis negative direction (a corner portion of the container 100 in the X-axis negative direction and in the Z-axis negative direction) is formed in a shape where surfaces extending in the X-axis direction and the Z-axis direction are recessed and the shape penetrates in the Y-axis direction. In other words, the first recessed portion 101 of the second side surface portion 120 is a recessed portion where a corner portion of the container 100 in the X-axis negative direction and in the Z-axis positive direction is recessed (cut out) in a quadrangular shape (L shape) as viewed in the Y-axis direction. The second recessed portion 102 of the second side surface portion 120 is a recessed portion where a corner portion of the container 100 in the X-axis negative direction and in the Z-axis negative direction is recessed (cut out) in a quadrangular shape as viewed in the Y-axis direction. In the second side surface portion 120, a portion that is interposed between the first recessed portion 101 and the second recessed portion 102 in the Z-axis direction forms a protruding portion 119. The protruding portion 119 of the second side surface portion 120 is a portion protruding more in the X-axis negative direction than the first upper side surface 121 and the second lower side surface 125.

In the container 100, both end surfaces that face each other in the Y-axis direction each form the long side surface 130. Each long side surface 130 is a flat surface that is parallel to the XZ plane and is elongated in the X-axis direction, and both end portions of the long side surface 130 in the X-axis direction have shapes corresponding to the first side surface portion 110 and the second side surface portion 120.

With respect to both end surfaces of the container 100 that face each other in the Z-axis direction, the end surface in the Z-axis positive direction is a top surface 140, and the end surface in the Z-axis negative direction is a bottom surface 150. The top surface 140 is a rectangular flat surface that is parallel to the XY plane and is elongated in the X-axis direction. The top surface 140 connects an upper end of the first upper side surface 111 of the first side surface portion 110 and an upper end of the second upper side surface 121 of the second side surface portion 120 to each other. The bottom surface 150 is a rectangular flat surface that is parallel to the XY plane and is elongated in the X-axis direction. The bottom surface 150 connects the lower end of the first lower side surface 115 of the first side surface portion 110 and the lower end of the second lower side surface 125 of the second side surface portion 120 to each other.

The container 100 includes a container body 160 and a lid body 170, and is formed in a substantially rectangular parallelepiped shape by assembling the container body 160 and the lid body 170. The container body 160 has a pair of long side surfaces 130 and the bottom surface 150. The lid body 170 has the first upper side surface 111, the first upper surface 112, the first intermediate side surface 113, the first lower surface 114, the first lower side surface 115, the second upper side surface 121, the second upper surface 122, the second intermediate side surface 123, the second lower surface 124, the second lower side surface 125, and the top surface 140.

Specifically, the container body 160 is a substantially U-shaped sheet metal with an upper side thereof opened as viewed in the X-axis direction. The container body 160 has flat plate-shaped long side wall portions that form a pair of the long side surfaces 130 at both end portions thereof in the Y-axis direction. The container body 160 has a flat plate-shaped rectangular bottom wall portion that forms the bottom surface 150 at an end portion in the Z-axis negative direction.

The lid body 170 is a sheet metal with a lower side thereof opened as viewed in the Y-axis direction. The lid body 170 has a bent plate portion that forms the first upper side surface 111, the first upper surface 112, the first intermediate side surface 113, the first lower surface 114, and the first lower side surface 115 at an end portion in the X-axis positive direction. The lid body 170 has a bent plate portion that forms the second upper side surface 121, the second upper surface 122, the second intermediate side surface 123, the second lower surface 124, and the second lower side surface 125 at an end portion in the X-axis negative direction. The lid body 170 has a flat plate-shaped rectangular top wall portion that forms the top surface 140 at an end portion in the Z-axis positive direction.

With such a configuration, the container 100 has the structure where the inside of the container 100 is sealed. Such sealed structure is obtained by housing the electrode assembly 700 and the like in the container body 160 and, thereafter, by joining the container body 160 and the lid body 170 to each other by welding or the like. A material of the container 100 (the container body 160 and the lid body 170) is not particularly limited. However, for example, it is preferable that the container 100 be made of weldable metal such as stainless steel, aluminum, an aluminum alloy, iron, or a plated steel plate.

Although not illustrated in the drawings in this embodiment, a solution filling portion and a gas release valve are formed on the lid body 170. The gas release valve is a safety valve that releases a pressure in the container 100 when such a pressure is excessively increased. The solution filling portion is a portion for filling an electrolyte solution into the container 100 at the time of manufacturing the energy storage device 10.

The electrode terminals 300 are terminals (a positive electrode terminal 310 and a negative electrode terminal 320) that are electrically connected to the electrode assembly 700 via the current collectors 600. That is, the electrode terminals 300 are metal-made members that are provided for discharging electricity stored in the electrode assembly 700 to an external space outside the energy storage device 10, and for charging electricity into an internal space in the energy storage device 10 so as to store electricity in the electrode assembly 700. Although a material of the electrode terminal 300 is not particularly limited, for example, the electrode terminals 300 (the positive electrode terminal 310 and the negative electrode terminal 320) are respectively formed of a conductive member made of aluminum, an aluminum alloy, copper, a copper alloy or the like. The electrode terminals 300 are connected (joined) to the current collectors 600 by swaging, welding or the like, and are mounted on the lid body 170.

In the present embodiment, the electrode terminal 300 includes a terminal body portion 330 and a shaft portion 340 that protrudes from the terminal body portion 330. The electrode terminal 300 may be a bolt terminal. The terminal body portion 330 is a portion that protrudes outward from a terminal mounting surface of the container 100. In this embodiment, the terminal mounting surface is formed of the first upper surface 112, the first lower surface 114, the second upper surface 122, or the second lower surface 124. At any terminal mounting surface, the terminal body portion 330 protrudes outward from the container 100 along the Z-axis direction. Through holes 112a, 114a, 122a, and 124a through which the shaft portion 340 passes are formed in the lid body 170 at positions corresponding to the respective terminal mounting surfaces. The shaft portion 340 is connected (joined) to the current collector 600 by swaging in a state where the shaft portion 340 penetrates the terminal mounting surface, the outer gasket 400, the inner gasket 500 and the current collector 600. The positional relationship between the terminal body portion 330 and the respective recessed portions (the first recessed portion 101 and the second recessed portion 102) after joining will be described later.

The current collectors 600 are current collecting members (the positive electrode current collector 610 and the negative electrode current collector 620) having conductivity. The current collectors 600 are disposed in pair on both sides of the electrode assembly 700 in the X-axis direction. The current collectors 600 are connected (joined) to the electrode assembly 700 and the electrode terminals 300 so as to electrically connect the electrode assembly 700 and the electrode terminals 300 to each other. Specifically, the current collector 600 is an integral body formed of: a first joint portion 630 that is connected (joined) to a tab portion 720 of the electrode assembly 700 described later by welding, swaging or the like; and a second joint portion 640 that is connected (joined) to the electrode terminal 300 by swaging, welding or the like as described above. The first joint portion 630 and the second joint portion 640 are each a flat plate-like portion. The first joint portion 630 and the second joint portion 640 are formed by bending one sheet metal. Although a material of the current collector 600 is not particularly limited, for example, the positive electrode current collector 610 is formed of a conductive member made of aluminum or an aluminum alloy or the like in the same manner as a positive electrode substrate 741 of the electrode assembly 700 described later, and the negative electrode current collector 620 is formed of a conductive member made of copper or a copper alloy or the like in the same manner as a negative electrode substrate 751 of the electrode assembly 700 described later.

The outer gasket 400 is a plate-like rectangular sealing member having insulating property that is disposed between the lid body 170 of the container 100 and the electrode terminal 300. The outer gasket 400 provides insulation and sealing between the lid body 170 and the electrode terminal 300. The inner gasket 500 is a plate-like rectangular sealing member having insulating property that is disposed between the lid body 170 and the current collector 600. The inner gasket 500 provides insulation and sealing between the lid body 170 and the current collector 600. The outer gasket 400 and the inner gasket 500 are made of a resin or the like having an electrically insulating material such as polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene/perfluoroalkyl vinyl ether (PFA), polytetrafluoroethylene (PTFE), polyether sulfone (PES), an ABS resin, or a composite material of the above-described materials.

The electrode assembly 700 is an energy storage element (a power generating element) that is formed by winding plates and can store electricity. The electrode assembly 700 has an elongated shape extending in the X-axis direction, and has an elongated circular shape as viewed in the X-axis direction. The electrode assembly 700 has a shape where a length in the X-axis direction is, for example, 300 mm or more, and more specifically, about 500 mm to 1500 mm. With such a configuration, the length of the electrode assembly 700 in the X-axis direction is set longer than the length of the electrode assembly 700 in the Z-axis direction. For example, the length of the electrode assembly 700 in the X-axis direction is 3 times or more as large as the length of the electrode assembly 700 in the Z-axis direction. The electrode assembly 700 includes the body portion 710 and a plurality of tab portions 720 protruding from the body portion 710. As described above, the tab portions 720 are connected (joined) to the current collectors 600. The tab portion 720 is an example of a connecting portion that is connected to the current collector 600.

Specifically, with respect to the plurality of tab portions 720, a pair of tab portions 720 protrudes from each of both end surfaces of the body portion 710 in the X-axis direction. For example, to one end surface of the body portion 710 in the X-axis positive direction, the positive electrode tab portion 721 is provided with a predetermined distance away from an end portion in the Z-axis positive direction, and the negative electrode tab portion 722 is provided with a predetermined distance away from an end portion in the Z-axis negative direction. On the other hand, to the other end surface of the body portion 710 in the X-axis negative direction, the negative electrode tab portion 722 is provided with a predetermined distance away from an end portion in the Z-axis positive direction, and the positive electrode tab portion 721 is provided with a predetermined distance away from an end portion in the Z-axis negative direction. That is, between the first end surface and the other end surface of the body portion 710, the positive electrode tab portion 721 and the negative electrode tab portion 722 are arranged in a reversed manner (upside down) as viewed in a direction along the winding axis (as viewed in the X-axis direction).

For example, in the case of an electrode assembly that is elongated in the X-axis direction and is configured such that positive electrode tab portions are provided only at one end portion of the electrode assembly in the X-axis direction and negative electrode tab portions are provided only at the other end portion of the electrode assembly in the X-axis direction, a distance between the positive electrode tab portions and the negative electrode tab portions becomes extremely long. Such a configuration is not preferable from a viewpoint that an electric resistance is increased and the occurrence of irregularities in reaction is induced. In the present embodiment, the positive electrode tab portion 721 and the negative electrode tab portion 722 are respectively provided to each of one end surface and the other end surface of the body portion 710 of the electrode assembly 700. Accordingly, a distance between the positive electrode tab portion 721 and the negative electrode tab portion 722 is shortened at each end surface of the body portion 710. As a result, the increase in an electric resistance and the occurrence of irregularities in reaction are suppressed. The configuration of such an electrode assembly 700 will be described in detail hereinafter.

### [Description of Configuration of Electrode Assembly 700]

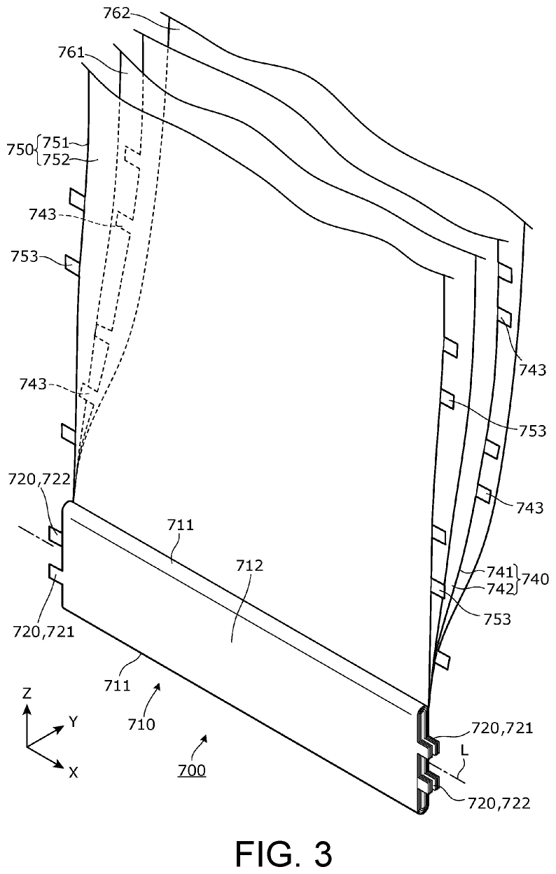

FIG. 3 is a perspective view illustrating the configuration of the electrode assembly 700 according to the embodiment 1. Specifically, FIG. 3 illustrates the configuration of the winding state of the plates in the electrode assembly 700 in a state where the winding state of the plates is partially developed. As illustrated in FIG. 3, the electrode assembly 700 includes a positive plate 740, a negative plate 750, and separators 761, 762.

The positive plate 740 is a plate (an electrode plate) that is formed such that a positive active material layer 742 is formed on a surface of the positive electrode substrate 741 that is an elongated strip-shaped metal foil made of aluminum or an aluminum alloy. The negative plate 750 is a plate (an electrode plate) that is formed such that a negative active material layer 752 is formed on a surface of the negative electrode substrate 751 that is an elongated strip-shaped metal foil made of copper or a copper alloy. As materials for forming the positive electrode substrate 741 and the negative electrode substrate 751, known materials such as nickel, iron, stainless steel, titanium, fired carbon, a conductive polymer, a conductive glass, and an Al—Cd alloy can be appropriately used provided that the materials are stable to an oxidation-reduction reaction during charging and discharging. As a positive active material used for forming the positive active material layer 742 and a negative active material used for forming the negative active material layer 752, known materials can be appropriately used provided that the materials are a positive active material and a negative active material capable of occluding and discharging lithium ions.

For example, as the positive active material, a polyanion compound such as LiMPO₄, LiMSiO₄, or LiMBO₃ (M representing one kind or two or more kinds of transition metal elements selected from Fe, Ni, Mn, Co, and the like), lithium titanate, a spinel-type lithium manganese oxide such as LiMn₂O₄ or LiMn_{1.5}Ni_{0.5}O₄, a lithium transition metal oxide such as LiMO₂ (M representing one kind or two or more kinds of transition metal elements selected from Fe, Ni, Mn, Co, and the like), or the like can be used. As the negative active material, besides lithium metal and a lithium alloy (lithium metal-containing alloys such as lithium-silicon, lithium-aluminum, lithium-lead, lithium-tin, lithium-aluminum-tin, lithium-gallium, and a wood's alloy), an alloy capable of occluding and releasing lithium, a carbon material (for example, graphite, non-graphitizable carbon, graphitizable carbon, low-temperature calcined carbon, amorphous carbon, and the like), a silicon oxide, a metal oxide, a lithium metal oxide (Li₄Ti₅O₁₂ or the like), a polyphosphoric acid compound, and a compound of transition metal and an element belong to any one of groups 14 to 16, such as Co₃O₄ or Fe₂P, that is generally referred to as a conversion negative electrode can be named.

The separators 761, 762 are each formed of a microporous sheet made of a resin. As a material of the separators 761 and 762, a known material can be appropriately used provided that the performance of the energy storage device 10 is not impaired. For example, as the separators 761 and 762, a woven fabric that is insoluble in an organic solvent, a nonwoven fabric, a synthetic resin microporous membrane made of a polyolefin resin such as polyethylene, or the like can be used.

The electrode assembly 700 is formed by alternately stacking and winding the positive plate 740, the negative plate 750, and the separators 761, 762. That is, the electrode assembly 700 is formed by stacking and winding the negative plate 750, the separator 761, the positive plate 740, and the separator 762 in this order. In the present embodiment, the electrode assembly 700 is a winding-type electrode assembly formed by winding the positive plate 740, the negative plate 750 and the like around the winding axis L extending in the X-axis direction. The winding axis L is a virtual axis that becomes a central axis when the positive plate 740, the negative plate 750 and the like are wound, and in the present embodiment, the winding axis L is a straight line which passes through the center of the electrode assembly 700 and is parallel to the X-axis direction.

On both end edges of the positive plate 740 in the winding axis direction, a plurality of protruding members 743 respectively protruding outward are disposed at intervals. In the same manner, on both end edges of the negative plate 750 in the winding axis direction, a plurality of protruding members 753 respectively protruding outward are disposed at intervals. In a state of the electrode assembly 700 after the stacking, the respective protruding members 743 of the positive plate 740 and the respective protruding members 753 of the negative plate 750 are alternately and repeatedly arranged by every two in the longitudinal direction of the positive plate 740 and the negative plate 750 respectively. Each of the protruding members 743 and 753 is a portion where the active material layer containing the active material is not formed and the substrate layer is exposed (an active material layer-non-formed portion).

When the positive plate 740, the negative plate 750, and the separators 761 and 762 are wound, the protruding members 743 of the positive plate 740 overlap with each other on one end surface of the body portion 710 and the protruding members 753 of the negative plate 750 overlap with each other on the other end surface of the body portion 710. A portion where the protruding members 743 of the positive plate 740 overlap with each other forms the positive electrode tab portion 721. That is, the positive electrode tab portion 721 is a portion formed by stacking a plurality of one members (protruding members 743) of the plates having the same polarity (the positive plates 740) out of the plurality of plates (the positive plate 740 and the negative plate 750).

In the same manner, a portion where the respective protruding members 753 of the negative plate 750 overlap with each other forms the negative electrode tab portion 722. That is, the negative electrode tab portion 722 is a portion formed by stacking a plurality of one members (protruding members 753) of the plates (the negative plates 750) having the same polarity out of the plurality of plates (the positive plate 740 and the negative plate 750).

As described above, the electrode assembly 700 includes: the body portion 710 that forms the electrode assembly body of the electrode assembly 700; and the plurality of tab portions 720 (the positive electrode tab portion 721 and the negative electrode tab portion 722) that protrude as a pair from both end surfaces of the body portion 710 in the X-axis direction respectively.

The body portion 710 is an elongated circular columnar portion (an active material layer forming portion) formed by winding portions of the positive plate 740 and the negative plate 750, the portions where the positive active material layer 742 and the negative active material layer 752 are formed (coated) and the separators 761 and 762. With such a configuration, the body portion 710 has a pair of curved portions 711 on both sides in the Z-axis direction, and the body portion 710 has a flat portion 712 having a flat shape as a whole between the pair of curved portions 711. It can also be said that the pair of curved portions 711 is disposed at positions that interpose the flat portion 712 in the Z-axis direction.

The curved portions 711 are each formed of a portion having a curved shape that is curved in a semicircular arc shape so as to protrude in the Z-axis direction as viewed in the X-axis direction and extend in the X-axis direction. One curved portion 711 is disposed so as to face the bottom wall portion of the container body 160 and the other curved portion 711 faces the top wall portion of the lid body 170. That is, the pair of curved portions 711 is portions that is curved so as to protrude from the flat portion 712 toward the bottom wall portion of the container body 160 and the top wall portion of the lid body 170 and toward both sides of the flat portion 712 in the Z-axis direction as viewed in the X-axis direction.

The flat portion 712 is a rectangular and flat portion that connects the end portions of the pair of curved portions 711 to each other and extends parallel to the XZ plane directed in the Y-axis direction. The flat portion 712 is disposed so as to face the long side wall portions of the container body 160 on both sides in the Y-axis direction. The flat portion 712 is a main portion of the electrode assembly 700. In the flat portion 712, a plurality of wound plates (the positive plate 740 and the negative plate 750) are stacked in the Y-axis direction. That is, in the flat portion 712, the Y-axis direction is a stacking direction of the plurality of plates. As described above, the flat portion 712 is a main portion of the electrode assembly 700 and hence, a main stacking direction of the electrode assembly 700 is defined as the Y-axis direction in the present disclosure.

The curved shape of the curved portion 711 is not limited to a semicircular arc shape, and may be a part of an elliptical shape or the like. That is, the curved shape may be curved in any shape. The flat portion 712 is not limited to a shape where an outer surface of the flat portion 712 directed in the Y-axis direction is a flat surface, and the outer surface may be slightly recessed or may be slightly bulged.

### [Positional Relationship Between Terminal Body Portion, Respective Recessed Portions, Electrode Assembly, and Current Collectors]

Next, the positional relationship between the terminal body portion 330, the respective recessed portions (the first recessed portions 101 and the second recessed portions 102), the electrode assembly 700, and the current collectors 600 is described. In this embodiment, the explanation is made by illustrating the first recessed portion 101 and the second recessed portion 102 of the first side surface portion 110 as an example. However, the second side surface portion 120 adopts substantially the same configuration and hence, the explanation of the second side surface portion 120 is omitted. The positive electrode terminal 310 and the negative electrode terminal 320 disposed on the second side surface portion 120 are examples of the other positive electrode terminal and the other negative electrode terminal. The positive electrode tab portion 721 and the negative electrode tab portion 722 disposed on the second side surface portion 120 are an example of a pair of other connecting portions.

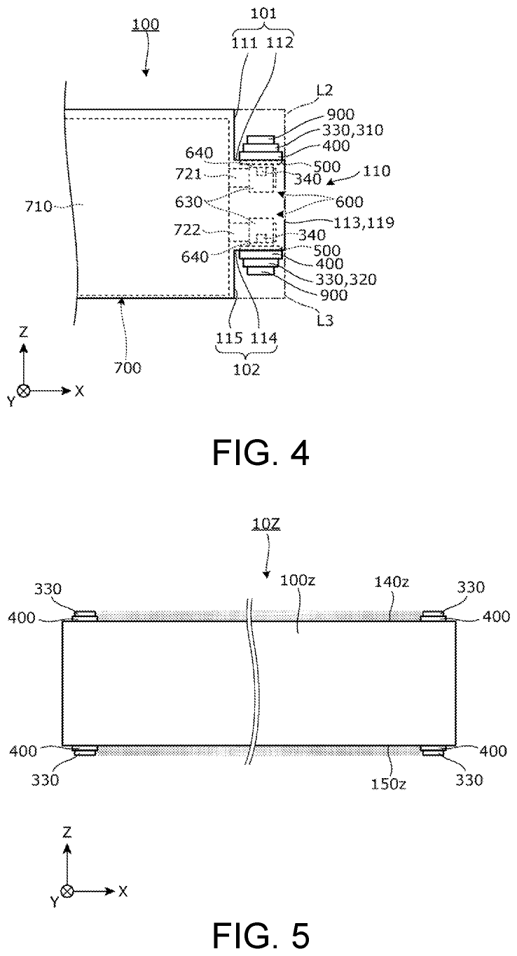

FIG. 4 is a plan view illustrating the first side surface portion 110 according to the embodiment 1. Also in FIG. 4, a rectangular parallelepiped shape of the container 100 that is used as a reference is indicated by a double-dashed chain lines L2, L3. Accordingly, the “inside of the first recessed portion 101” means the inside of a region that is defined by a profile having a rectangular parallelepiped shape (double-dashed chain line L2) that is used as the reference, the first upper side surface 111, and the first upper surface 112. In the same manner, the “inside of the second recessed portion 102” means the inside of a region defined by a profile having a rectangular parallelepiped shape (double-dashed chain line L3) that is used as the reference, the first lower surface 114, and the first lower side surface 115.

FIG. 4 illustrates a state where a bus bar 900 is joined to each terminal body portion 330. The bus bars 900 are plate-like conductive members extending in the Y-axis direction, and are joined to the electrode terminals 300 of other energy storage devices.

As illustrated in FIG. 4, in the first recessed portion 101, the terminal body portion 330 of the positive electrode terminal 310 is mounted on the first upper surface 112 that forms the terminal mounting surface in a protruding manner outward through the outer gasket 400. In this state, the entirety of the terminal body portion 330 of the positive electrode terminal 310 is accommodated in the first recessed portion 101 as viewed in the Y-axis direction. That is, the terminal body portion 330 of the positive electrode terminal 310 is disposed below the top surface 140 as a whole. Further, the entirety of the bus bar 900 joined to the positive electrode terminal 310 is also accommodated in the first recessed portion 101 and is disposed below the top surface 140 as viewed in the Y-axis direction.

In the first side surface portion 110, the positive electrode tab portion 721 and the negative electrode tab portion 722 of the electrode assembly 700 in the X-axis positive direction are disposed between the first recessed portion 101 and the second recessed portion 102. That is, the positive electrode tab portion 721 and the negative electrode tab portion 722 are disposed in the protruding portion 119 on the first side surface portion 110. With such a configuration, the positive electrode tab portion 721 and the negative electrode tab portion 722 are disposed at positions that are retracted from the portions which form the first upper side surface 111 and the first lower side surface 115 respectively. Accordingly, the body portion 710 of the electrode assembly 700 can be disposed close to the portions which form the first upper side surface 111 and the first lower side surface 115 respectively. Accordingly, it is possible to form the body portion 710 that is a portion contributing to the storage of power (generation of power) as large as possible.

The current collector 600 joined to the positive electrode tab portion 721 extends in the Z-axis direction in a space that overlaps with the first upper surface 112 when the first upper surface 112 that forms the terminal mounting surface is viewed in a plan view. Specifically, the first joint portion 630 of the current collector 600 joined to the positive electrode tab portion 721 is a plate-like portion extending in the Z-axis direction, and is joined to the positive electrode tab portion 721. The second joint portion 640 of the current collector 600 is a plate-like portion bent from an upper end of the first joint portion 630, and is joined to the shaft portion 340 of the positive electrode terminal 310. The first joint portion 630 and the second joint portion 640 are accommodated in a space that overlaps with the first upper surface 112 when the first upper surface 112 is viewed in a plan view. That is, the first joint portion 630 and the positive electrode tab portion 721 are joined to each other in the space in a state where the current collector 600 does not protrude from the space, and the joining structure of these constitutional elements also does not protrude from the space.

On the other hand, in the second recessed portion 102, the terminal body portion 330 of the negative electrode terminal 320 is mounted on the first lower surface 114 that forms the terminal mounting surface in a protruding manner outward through the outer gasket 400. In this state, the entirety of the terminal body portion 330 of the negative electrode terminal 320 is accommodated in the second recessed portion 102 as viewed in the Y-axis direction. That is, the terminal body portion 330 of the negative electrode terminal 320 is disposed above the bottom surface 150 as a whole. Further, the entirety of the bus bar 900 joined to the negative electrode terminal 320 is also accommodated in the second recessed portion 102 as viewed in the Y-axis direction, and is disposed above the bottom surface 150.

As descried previously, the second side surface portion 120 also has substantially the same configuration as the first side surface portion 110. Accordingly, the terminal body portion 330 and the bus bar 900 in each of the first recessed portions 101 are disposed below the top surface 140 and do not protrude from the top surface 140. In the same manner, the terminal body portion 330 and the bus bar 900 in each of the second recessed portions 102 are disposed above the bottom surface 150 and do not protrude from the bottom surface 150.

The current collector 600 joined to the negative electrode tab portion 722 extends in the Z-axis direction in a space that overlaps with the first lower surface 114 when the first lower surface 114 that forms the terminal mounting surface is viewed in a plan view. Specifically, the first joint portion 630 of the current collector 600 joined to the negative electrode tab portion 722 is a plate-like portion extending in the Z-axis direction, and is joined to the negative electrode tab portion 722. The second joint portion 640 of the current collector 600 is a plate-like portion bent from an upper end of the first joint portion 630, and is joined to the shaft portion 340 of the negative electrode terminal 320. The first joint portion 630 and the second joint portion 640 are accommodated in a space that overlaps with the first lower surface 114 when the first lower surface 114 is viewed in a plan view. That is, the first joint portion 630 and the negative electrode tab portion 722 are joined to each other in the space in a state where the current collector 600 does not protrude from the space, and the joining structure of these constitutional elements also does not protrude from the space. As described above, also the joining structure between the positive electrode tab portion 721 and the current collector 600 does not protrude from the space and hence, the body portion 710 of the electrode assembly 700 can be disposed as large as possible.

FIG. 5 is a plan view schematically illustrating an energy storage device 10Z according to a comparative example. As illustrated in FIG. 5, in the energy storage device 10Z, a container 100z has neither first recessed portions nor second recessed portions. That is, the container 100z is formed in a rectangular parallelepiped shape. Accordingly, in the comparative example, a pair of electrode terminals 300 is mounted on a top surface 140z of the container 100z, and a pair of electrode terminals 300 is also mounted on a bottom surface 150z. In the top surface 140z of the energy storage device 10z of the comparative example, the pair of electrode terminals 300 protrudes from the top surface 140z and hence, a space between the pair of electrode terminals 300 becomes a surplus space (a dotted hatching portion in FIG. 5). In the same manner, on the bottom surface 150z, the pair of electrode terminals 300 protrudes from the bottom surface 150z and hence, a space between the pair of electrode terminals 300 becomes a surplus space.

To the contrary, in the present embodiment, the terminal body portion 330 in each of the first recessed portions 101 does not protrude from the top surface 140 and hence, a surplus space outside the container 100 is reduced between the pair of electrode terminals 300 disposed on the upper portion of the container 100 (see FIG. 4). In the same manner, also between the pair of electrode terminals 300 disposed on the lower portion of the container 100, a surplus space outside the container 100 is reduced. That is, by reducing a surplus space outside the container 100, an internal space of an outer case that accommodates the energy storage devices 10 can be efficiently utilized.

### [Description of Advantageous Effects of Embodiment 1]

As described above, in the energy storage device 10 according to the embodiment 1, the pair of connecting portions (the positive electrode tab portion 721 and the negative electrode tab portion 722) of the electrode assembly 700 is disposed in the protruding portions 119 of each of the first side surface portion 110 and the second side surface portion 120 and hence, spaces used for the pair of connecting portions in the container 100 can be collectively disposed in the protruding portions 119. With such a configuration, the space other than the protruding portions 119 in the container 100 is minimally used for the pair of connecting portions. Although the electrode assembly body (the body portion 710) that contributes to the generation of power (the storage of energy) is accommodated in the space other than the protruding portions 119 in the container 100, the space is minimally used for the pair of connecting portions and hence, the electrode assembly body can be large-sized in the space. As a result, it is possible to increase the energy density.

The positive electrode terminal 310 and the negative electrode terminal 320 are disposed in each of the pair of recessed portions (the first recessed portion 101 and the second recessed portion 102) that interposes the protruding portion 119 therebetween. Accordingly, a protruding amount of the respective terminals (the positive electrode terminal 310 and the negative electrode terminal 320) from the container 100 can be suppressed. Accordingly, it is possible to reduce an energy storage device accommodating space outside the container 100 attributed to the respective terminals (a surplus space).

In the flat energy storage device 10, the first upper surface 112 and the first lower surface 114 that form the terminal mounting surfaces opposedly face each other in the arrangement direction of the pair of connecting portions (in the Z-axis direction). Accordingly, the first upper surface 112 and the positive electrode terminal 310 can be disposed close to each other, and the first lower surface 114 and the negative electrode terminal 320 can be disposed close to each other. Accordingly, the electrical connection structure (the current collectors 600) between the terminals and the connecting portions can be accommodated in the protruding portion 119. That is, it is possible to suppress the electrical connection structure from using the space other than the protruding portion 119 and hence, the body portion 710 can be made more large-sized. Accordingly, it is possible to increase the energy density.

The entireties of the terminal body portions 330 are accommodated in the first recessed portions 101 formed on the side surface portions (the first side surface portion 110 and the second side surface portion 120) of the container 100 and hence, a protruding amount of the terminal body portions 330 from the container 100 can be eliminated. With such a configuration, a surplus space outside the container 100 attributed to the electrode terminals 300 can be reduced. As a result, it is possible to suppress the lowering of the space utilization efficiency of the energy storage device 10. In this embodiment, the space utilization efficiency means the degree of effective use of the space where the energy storage device 10 is mounted, it may be expressed that, when a surplus space is large, the degree of effective use is low so that the space utilization efficiency is also lowered.

The first recessed portion 101 is disposed on the first side surface portion 110 and the second side surface portion 120 at the end portion in the Z-axis positive direction (one end portion in the second direction) respectively and hence, the first recessed portion 101 can be formed in a shape that the end portion in the Z-axis positive direction is opened. With such a configuration, workability in joining the conductive members such as bus bars 900 to the terminal body portion 330 from the Z-axis positive direction can be enhanced.

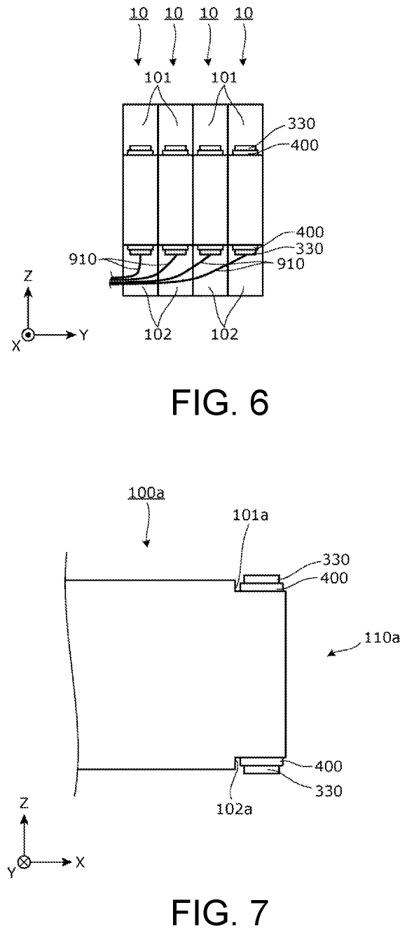

On each of the first side surface portion 110 and the second side surface portion 120, the second recessed portion 102 is disposed at the position different from the position of the first recessed portion 101. Accordingly, members other than the energy storage devices 10 (such as wirings for measuring a voltage or a temperature) can be disposed in the second recessed portions 102. FIG. 6 is an explanatory view illustrating a state where a wire 910 for measuring a voltage is mounted on the second recessed portion 102 according to the embodiment 1. FIG. 6 illustrates a state where the plurality of energy storage devices 10 are arranged in the Y-axis direction. In each energy storage device 10, the wire 910 for measuring a voltage is joined (connected) to the terminal body portion 330 of the electrode terminal 300 disposed in the second recessed portion 102. The wire 910 is provided for each energy storage device 10, and each wire 910 is disposed in the second recessed portion 102 of the energy storage device 10, and the wires 910 are pulled out to the outside of the plurality of energy storage devices 10. As described above, each wire 910 can be arranged in the second recessed portion 102 and hence, it is possible to suppress each wire 910 from protruding to the outside of the container 100. Accordingly, it is possible to enhance the space utilization efficiency outside the energy storage device 10.

Also on the second side surface portion 120 (the other end portion) of the container 100, the other protruding portion 119 where the pair of other connecting portions (the positive electrode tab portion 721 and the negative electrode tab portion 722 in the X-axis negative direction) is disposed is formed. Accordingly, also in the energy storage device 10 that includes the electrode assembly 700 where the pair of connecting portions 720 protrudes from both end portions respectively, the electrode assembly body 710 can be made large-sized.

Also in the winding-type electrode assembly 700, the electrode assembly body (the body portion 710) can be made large-sized in spaces other than the protruding portions 119 of the container 100. As a result, it is possible to increase the energy density of the energy storage device 10 using the winding-type electrode assembly 700.

### [Description of Modifications of Embodiment 1]

Hereinafter, respective modifications of the above-mentioned embodiment 1 will be described. In the following description, components equivalent to the components in the above-mentioned embodiment 1 or other modifications are denoted by the same reference numerals, and the description of these components may be omitted. In the following description, the first side surface portion will be described as an example. However, the second side surface portion also has substantially the same shape as the first side surface portion.

### Modification 1 of Embodiment 1

The modification 1 of the above-mentioned embodiment 1 will be described. FIG. 7 is a plan view illustrating a first side surface portion 110a according the modification 1 of the embodiment 1. In the above-mentioned embodiment 1, the case is exemplified where the entirety of the terminal body portion 330 of each electrode terminal 300 is accommodated in the respective recessed portions (the first recessed portions 101 and the second recessed portions 102). In the modification 1, the description will be made with respect to a case where a portion of the terminal body portion 330 of each electrode terminal 300 is disposed in the respective recessed portions.

As illustrated in FIG. 7, in the first side surface portion 110a, only an end portion of the terminal body portion 330 in the Z-axis positive direction protrudes from the first recessed portion 101a, and other portions of the terminal body portion 330 are accommodated in the first recessed portion 101a. That is, as compared with the comparative example, a protruding amount of the terminal body portion 330 from a top surface 140a of a container 100a is suppressed. Accordingly, a surplus space outside an upper portion of the container 100a attributed to the electrode terminal 300 can be reduced.

In the first side surface portion 110a, only an end portion of the terminal body portion 330 in the Z-axis negative direction protrudes from the second recessed portion 102a from the second recessed portion 102a, and other portions of the terminal body portion 330 are accommodated in the second recessed portion 102a. That is, as compared with the comparative example, a protruding amount of the terminal body portion 330 from a bottom surface 150a of the container 100a is suppressed. Accordingly, a surplus space outside a lower portion of the container 100a attributed to the electrode terminal 300 can be reduced.

### Modification 2 of Embodiment 1

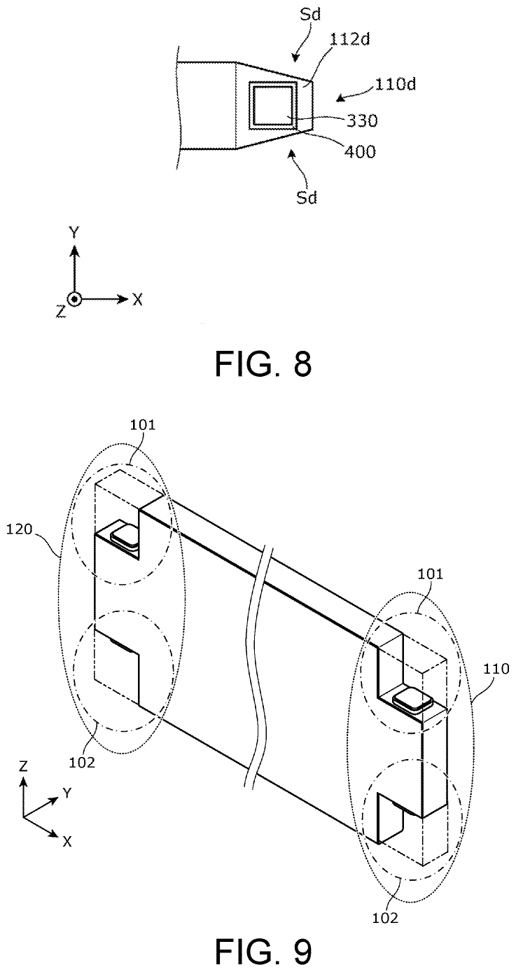

Next, a modification 2 of the above-mentioned embodiment 1 will be described. FIG. 8 is a top plan view illustrating a first side surface portion 110d according to the modification 2 of the embodiment 1. In the above-mentioned embodiment 1, the case is exemplified where the first upper surface 112 and the first lower surface 114 of the first side surface portion 110 have a rectangular shape as viewed in a plan view (as viewed in the Z-axis direction). In the modification 2, a case will be exemplified where a first upper surface 112d and a first lower surface (not illustrated) have a trapezoidal shape as viewed in a plan view (as viewed in the Z-axis direction). In FIG. 8, although only the first upper surface 112d is illustrated, the first lower surface also has substantially the same shape as the first upper surface 112d.

As illustrated in FIG. 8, the first upper surface 112d has a trapezoidal shape where a distal end portion (an end portion in the X-axis positive direction) has a width (a width in the Y-axis direction) narrower than a width (a width in the Y-axis direction) of a proximal end portion (an end portion in the X-axis negative direction). That is, the first upper surface 112d has a tapered shape as viewed in the Z-axis direction. As described above, the first lower surface also has substantially the same shape as the first upper surface 112d and hence, it may be expressed that the first side surface portion 110d also has a tapered shape as viewed in the Z-axis direction. So long as the first side surface portion 110d is tapered as viewed in the Z-axis direction, the first upper surface 112d and the first lower surface may have a shape other than a trapezoidal shape (for example, a triangular shape or the like) as viewed in plan view.

In this manner, the first side surface portion 110d has the tapered shape as viewed in the Z-axis direction and hence, a space Sd can be formed on each of the sides of the first side surface portion 110d in the lateral direction (the Y-axis direction). In the spaces Sd, members other than the energy storage device 10 (for example, wires and the like) can be disposed and hence, the space utilization efficiency of the energy storage device can be enhanced.

### Embodiment 2

### [Description of Overall Configuration of Energy Storage Device]

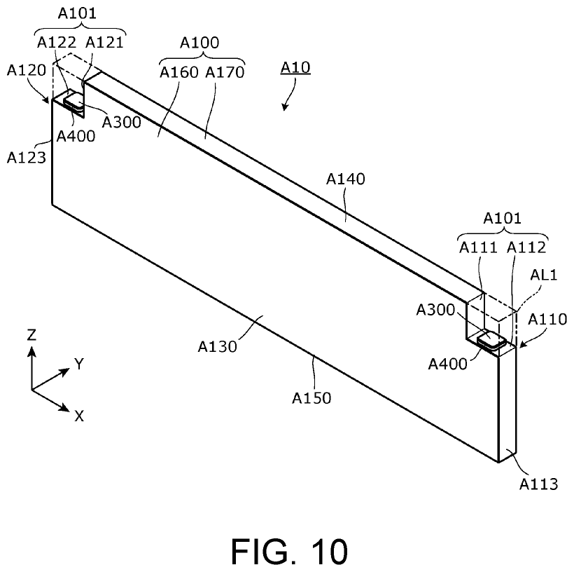

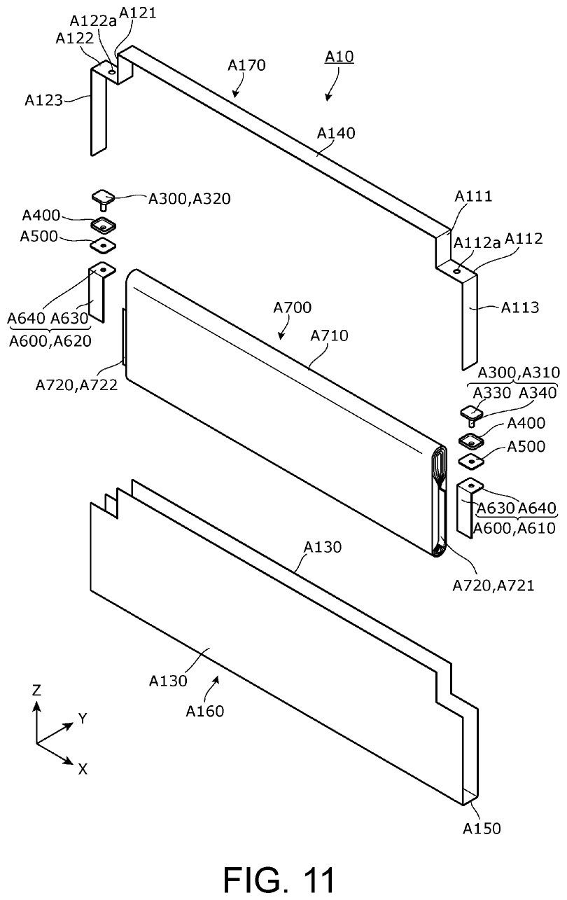

The overall configuration of an energy storage device A10 according to the embodiment 2 will be described with reference to FIG. 10 and FIG. 11. FIG. 10 is a perspective view illustrating an external appearance of the energy storage device A10 according to the embodiment 2. FIG. 11 is an exploded perspective view of the energy storage device A10 according to the embodiment 2 illustrating respective constitutional elements in a state where the energy storage device A10 is disassembled.

The energy storage device A10 is an energy storage device into which electricity can be charged from the outside and from which electricity can be discharged to the outside. In this embodiment, the energy storage device A10 has an approximately rectangular parallelepiped shape. For example, the energy storage device A10 is a battery used in an electricity storage application, a power source application, or the like. Specifically, the energy storage device A10 is used as a battery or the like for driving a mobile body such as an automobile, a motorcycle, a watercraft, a ship, a snowmobile, an agriculture machine, a construction machine, or a railway vehicle for an electric railway, or is used as a battery for starting an engine of the mobile body. As the above-described automobile, an electric vehicle (EV), a hybrid electric vehicle (HEV), a plug-in hybrid electric vehicle (PHEV), and an automobile that uses a fossils fuel (a gasoline, a light oil, a liquefied natural gas or the like) are exemplified. As an example of the railway vehicle for the electric railway described above, a train, a monorail, a linear motor car, and a hybrid train including both a diesel engine and an electric motor are exemplified. The energy storage device A10 can also be used as a stationary battery or the like used as a home-use battery, a business-use battery, or the like.

The energy storage device A10 is not limited to a non-aqueous electrolyte secondary battery. The energy storage device A10 may be a secondary battery other than the non-aqueous electrolyte secondary battery, or may be a capacitor. The energy storage device A10 may not be a secondary battery but a primary battery. Further, the energy storage device A10 may be a battery that uses a solid electrolyte. Still further, the energy storage device A10 may be a pouch-type energy storage device. In the present embodiment, the energy storage device A10 that uses a flat rectangular parallelepiped shape as the reference is illustrated. However, the shape of the energy storage device A10, that is, a shape of a container A100 is not limited to a shape that is formed using a rectangular parallelepiped shape as the reference, and may be a shape that is formed using a polygonal columnar shape, an elongated circular columnar shape, an elliptical columnar shape, a circular columnar shape or the like other than the rectangular parallelepiped shape.

As illustrated in FIG. 10 and FIG. 11, the energy storage device A10 includes: the container A100; a pair of electrode terminals A300, and a pair of outer gaskets A400. In the container A100, a pair of inner gaskets A500, a pair of current collectors A600, and an electrode assembly A700 are accommodated. Specifically, respective members (the electrode terminal A300, the outer gasket A400, the inner gasket A500, the current collector A600, and the like, the same understanding being adopted in the description made hereinafter) of a positive electrode are disposed on one end portion of the container A100 in the X-axis positive direction. The respective members of a negative electrode are disposed at the other end portion of the container A100 in the X-axis negative direction. To be further more specific, on a first side surface portion A110 of the container A100 in the X-axis positive direction, the respective members of the positive electrode are disposed at the end portion in the Z-axis positive direction. That is, the first side surface portion A110 is a range where the respective members of the positive electrode are disposed from an end surface of the container A100 in the X-axis positive direction. For example, in the X-axis direction, the first side surface portion A110 is a portion within a range of 1% to 10% of a length of the container A100 from the end surface of the container A100 in the X-axis positive direction.

On a second side surface portion A120 of the container A100 in the X-axis negative direction, respective members of the negative electrode are disposed at an end portion in the Z-axis positive direction. That is, the second side surface portion A120 is a range in which the respective members of the negative electrode are disposed from an end surface of the container A100 in the X-axis negative direction. For example, in the X-axis direction, the second side surface portion A120 is a portion within a range of 1% to 10% of the length of the container A100 from the end surface of the container A100 in the X-axis negative direction.

Although an electrolytic solution (non-aqueous electrolyte) is sealed in the container A100, the illustration of the electrolyte solution is omitted. A kind of the electrolyte solution is not particularly limited provided that the performance of the energy storage device A10 is not impaired, and various kinds of electrolyte solutions can be selected. Besides the constitutional elements described above, in the energy storage device A10, spacers that are disposed on the sides of the electrode assembly A700 or above or below the electrode assembly A700, an insulating film that wraps the electrode assembly A700 and the like, and the like may be disposed.

The container A100 is a case having a profile (substantially rectangular parallelepiped shape) that uses a flat rectangular parallelepiped shape elongated in the X-axis direction as the reference. For example, the container A100 has a length in the X-axis direction 3 times or more as large as the length in the Z-axis direction. In FIG. 10, a rectangular parallelepiped shape that is used as a reference is indicated by a double-dashed chain line AL1. Specifically, the container A100 has a profile where a cutout having a rectangular shape is formed at upper portions of both end portions in the X-axis direction of a flat rectangular parallelepiped shape elongated in the X-axis direction. It can be also said that each cutout forms a recessed portion A101 from a viewpoint of the rectangular parallelepiped shape that is used as the reference. That is, the recessed portion A101 is formed on each of the first side surface portion A110 and the second side surface portion A120 of the container A100 at an end portion in the Z-axis positive direction. Further, the electrode terminal A300 is disposed in the recessed portion A101. With such a configuration, in each of the first side surface portion A110 and the second side surface portion A120 of the container A100, the recessed portion A101 and (the entirety of) the electrode terminal A300 in the recessed portion A101 overlap with each other in the Z-axis direction.

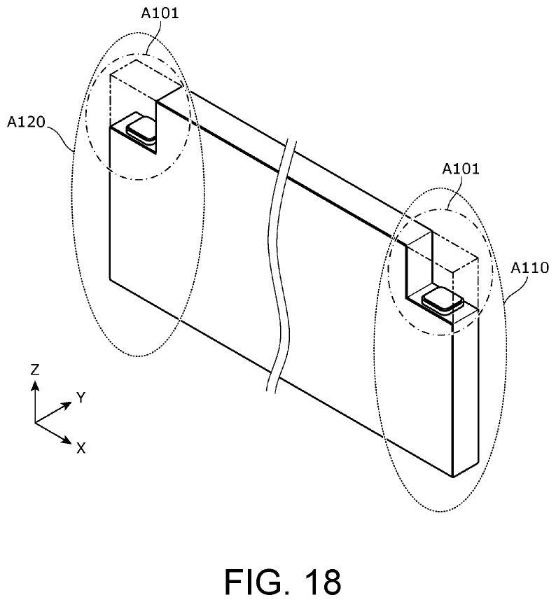

FIG. 18 is an explanatory view illustrating rough positions of the first side surface portion A110, the second side surface portion A120, and the recessed portions A101 according to the embodiment 2. In FIG. 18, the first side surface portion A110 and the second side surface portion A120 are surrounded by a broken line, and the recessed portions A101 are surrounded by a dotted chain line.

As illustrated in FIG. 10 and FIG. 11, specifically, the first side surface portion A110 includes a first upper side surface A111, a first upper surface A112, and a first side surface A113. The first side surface portion A110 is elongated in the Z-axis direction as viewed in the X-axis direction. The first upper side surface A111 is disposed above an upper portion of the first side surface portion A110, and is a rectangular flat surface that is parallel to the YZ plane and is elongated in the Z-axis direction. The first upper surface A112 is a flat surface that extends in the X-axis positive direction from a lower end of the first upper side surface A111, and is a rectangular flat surface that is parallel to the XY plane and is elongated in the X-axis direction. The first side surface A113 is a flat surface that extends downward from an end portion of the first upper surface A112 in the X-axis positive direction, and is a rectangular flat surface that is parallel to the YZ plane and is elongated in the Z-axis direction. The first recessed portion A101 of the first side surface portion A110 is defined by the first upper side surface A111 and the first upper surface A112, and an end portion in the Z-axis positive direction and an end portion in the X-axis positive direction are opened. With such a configuration, an end portion of the first side surface portion A110 in the Z-axis positive direction (a corner portion of the container A100 in the X-axis positive direction and in the Z-axis positive direction) is formed in a shape where a surface extending in the X-axis direction and a surface extending in the Z-axis direction are recessed and a cutout penetrates in the Y-axis direction. In other words, the recessed portion A101 of the first side surface portion A110 is a recessed portion where the corner portion of the container A100 in the X-axis positive direction and in the Z-axis positive direction is recessed (cut out) in a quadrangular shape (L shape) as viewed in the Y-axis direction.

The second side surface portion A120 includes a second upper side surface A121, a second upper surface A122, and a second side surface A123. The second side surface portion A120 is elongated in the Z-axis direction as viewed in the X-axis direction. The second upper side surface A121 is disposed above an upper portion of the second side surface portion A120, and is a rectangular flat surface that is parallel to the YZ plane and is elongated in the Z-axis direction. The second upper surface A122 is a flat surface that extends in the X-axis negative direction from a lower end of the second upper side surface A121, and is a rectangular flat surface that is parallel to the XY plane and is elongated in the X-axis direction. The second side surface A123 is a flat surface that extends downward from an end portion of the second upper surface A122 in the X-axis negative direction, and is a rectangular flat surface that is parallel to the YZ plane and is elongated in the Z-axis direction. With such a configuration, the recessed portion A101 of the second side surface portion A120 is defined by the second upper side surface A121 and the second upper surface A122, and an end portion in the Z-axis positive direction and an end portion in the X-axis negative direction are opened. With such a configuration, an end portion of the second side surface portion A120 in the Z-axis positive direction (a corner portion of the container A100 in the X-axis negative direction and in the Z-axis positive direction) is formed in a shape where a surface extending in the X-axis direction and a surface extending in the Z-axis direction are recessed and a cutout penetrates in the Y-axis direction. In other words, the recessed portion A101 of the second side surface portion A120 is a recessed portion where a corner portion of the container A100 in the X-axis negative direction and in the Z-axis positive direction is recessed (cut out) in a quadrangular shape as viewed in the Y-axis direction.

In the container A100, both end surfaces that face each other in the Y-axis direction each form a long side surface A130. Each long side surface A130 is a flat surface that is parallel to the XZ plane and is elongated in the X-axis direction. Both end portions of the long side surface A130 in the X-axis direction have shapes that respectively correspond to the first side surface portion A110 and the second side surface portion A120.

Further, with respect to both end surfaces of the container A100 that face each other in the Z-axis direction, the end surface in the Z-axis positive direction forms a top surface A140, and the end surface in the Z-axis negative direction forms a bottom surface A150. The top surface A140 is a rectangular flat surface that is parallel to the XY plane and is elongated in the X-axis direction. The top surface A140 connects an upper end of the first upper side surface A111 of the first side surface portion A110 and an upper end of the second upper side surface A121 of the second side surface portion A120 to each other. The bottom surface A150 is a rectangular flat surface that is parallel to the XY plane and is elongated in the X-axis direction. The bottom surface A150 connects a lower end of the first side surface A113 of the first side surface portion A110 and a lower end of the second side surface A123 of the second side surface portion A120 to each other.

The container A100 includes a container body A160 and a lid body A170, and is formed in a substantially rectangular parallelepiped shape by assembling the container body A160 and the lid body A170. The container body A160 has a pair of long side surfaces A130 and the bottom surface A150. The lid body A170 has the first upper side surface A111, the first upper surface A112, the first side surface A113, the second upper side surface A121, the second upper surface A122, the second side surface A123, and the top surface A140.

Specifically, the container body A160 is a sheet metal having a substantially U-shape with an upper side thereof opened as viewed in the X-axis direction. The container body A160 has flat plate-shaped long side wall portions that form a pair of the long side surfaces A130 at both end portions in the Y-axis direction, and has a flat plate-shaped rectangular bottom wall portion forming the bottom surface A150 at an end portion in the Z-axis negative direction.

The lid body A170 is a sheet metal with a lower side thereof opened as viewed in the Y-axis direction. The lid body A170 has a bent plate portion that forms the first upper side surface A111, the first upper surface A112, and the first side surface A113 at an end portion in the X-axis positive direction, has a bent plate portion that forms the second upper side surface A121, the second upper surface A122, and the second side surface A123 at an end portion in the X-axis negative direction, and has a flat plate-shaped and rectangular top wall portion forming the top surface A140 at an end portion in the Z-axis positive direction.

With such a configuration, the container A100 has the structure where the inside of the container A100 is sealed. Such sealed structure is obtained by housing the electrode assembly A700 and the like in the container body A160 and, thereafter, by joining the container body A160 and the lid body A170 to each other by welding or the like. A material of the container A100 (the container body A160 and the lid body A170) is not particularly limited. However, for example, it is preferable that the container A100 be made of metal that is weldable such as stainless steel, aluminum, an aluminum alloy, iron, or a plated steel plate.

Although not illustrated in the drawings in this embodiment, a solution filling portion and a gas release valve are formed on the lid body A170. The gas release valve is a safety valve that releases a pressure in the container A100 when the pressure is excessively increased. The solution filling portion is a portion for filling an electrolyte solution into the inside of the container A100 at the time of manufacturing the energy storage device A10.

The electrode terminals A300 are terminals (a positive electrode terminal A310 and a negative electrode terminal A320) that are electrically connected to the electrode assembly A700 via the current collectors A600. That is, the electrode terminals A300 are members made of metal that are provided for discharging electricity stored in the electrode assembly A700 to a space outside the energy storage device A10, and for charging electricity into a space inside the energy storage device A10 so as to store the electricity in the electrode assembly A700. Although the material of the electrode terminal A300 is not particularly limited, for example, the electrode terminals A300 (the positive electrode terminal A310 and the negative electrode terminal A320) are respectively formed of a conductive member such as aluminum, an aluminum alloy, copper, or a copper alloy. The electrode terminals A300 are connected (joined) to the current collector A600 by swaging, welding, or the like, and are mounted on the lid body A170.

In the present embodiment, the electrode terminal A300 includes a terminal body portion A330 and a shaft portion A340 protruding from the terminal body portion A330. The terminal body portion A330 is a portion that protrudes outward from a terminal mounting surface of the container A100. In this embodiment, the terminal mounting surface is formed of the first upper surface A112 or the second upper surface A122. At any terminal mounting surface, the terminal body portion A330 protrudes outward from the container A100 along the Z-axis direction. Through holes A112a, A122a through which the shaft portion A340 passes are formed in the lid body A170 at positions corresponding to the respective terminal mounting surfaces. The shaft portion A340 is connected (joined) to the current collector A600 by swaging in a state where the shaft portion A340 penetrates the terminal mounting surface, the outer gasket A400, the inner gasket A500 and the current collector A600. The positional relationship between the terminal body portion A330 and the respective recessed portions A101 after joining will be described later.

The current collectors A600 are current collecting members (the positive electrode current collector A610 and the negative electrode current collector A620) having conductivity. One positive electrode current collector A610 and one negative electrode current collector A620 are disposed on each of both sides of the electrode assembly A700 in the X-axis direction. The current collectors A600 are connected (joined) to the electrode assembly A700 and the electrode terminals A300 so as to electrically connect the electrode assembly A700 and the electrode terminals A300 to each other. Specifically, the current collector A600 is an integral body formed of: a first joint portion A630 that is connected (joined) to a connecting portion A720 of the electrode assembly A700 described later by welding, swaging or the like; and a second joint portion A640 that is connected (joined) to the electrode terminal A300 by swaging, welding or the like as described above thus being fixed to the lid body A170. The first joint portion A630 and the second joint portion A640 are each a flat plate-like portion. The first joint portion A630 and the second joint portion A640 are formed by bending one sheet metal. Details of the current collector A600 will be described later.

Although a material of the current collector A600 is not particularly limited, for example, the positive electrode current collector A610 is formed of a conductive member made of aluminum or an aluminum alloy or the like in the same manner as a positive electrode substrate A741 of the electrode assembly A700 described later, and the negative electrode current collector A620 is formed of a conductive member made of copper or a copper alloy or the like in the same manner as a negative electrode substrate A751 of the electrode assembly A700 described later.

The outer gasket A400 is a plate-like rectangular sealing member having insulating property that is disposed between the lid body A170 of the container A100 and the electrode terminal A300. The outer gasket A400 provides insulation and sealing between the lid body A170 and the electrode terminal A300. The inner gasket A500 is a plate-like rectangular sealing member having insulating property that is disposed between the lid body A170 and the current collector A600. The inner gasket A500 provides insulation and sealing between the lid body A170 and the current collector A600. The outer gasket A400 and the inner gasket A500 are made of a resin having an electrically insulating property such as polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene/perfluoroalkyl vinyl ether (PFA), polytetrafluoroethylene (PTFE), polyether sulfone (PES), an ABS resin, or a composite material of the above-described materials, for example.

The electrode assembly A700 is an energy storage element (power generating element) that is formed by winding plates and can store electricity. The electrode assembly A700 has an elongated shape extending in the X-axis direction, and has an elongated circular shape as viewed in the X-axis direction. The electrode assembly A700 has a shape where a length in the X-axis direction is, for example, 300 mm or more, and more specifically, about 500 mm to 1500 mm. With such a configuration, the length of the electrode assembly A700 in the X-axis direction is set longer than the length of the electrode assembly A700 in the Z-axis direction. For example, the length of the electrode assembly A700 in the X-axis direction is 3 times or more as large as the length of the electrode assembly A700 in the Z-axis direction. The electrode assembly A700 includes the body portion A710 and a pair of connecting portions A720 protruding from both end portions of the body portion A710. As described above, the connecting portions A720 are connected (joined) to the current collectors A600.

Specifically, the plurality of connecting portions A720 protrude from an intermediate portion between both end portions of the body portion A710 in the X-axis direction. For example, a positive electrode connecting portion A721 is disposed at an intermediate portion of the main body portion A710 in the Z-axis direction on one end surface of the main body portion A710 in the X-axis positive direction, and the negative electrode connecting portion A722 is disposed at an intermediate portion of the main body portion A710 in the Z-axis direction on the other end surface in the X-axis negative direction of the main body portion A710. The configuration of such an electrode assembly A700 will be described in detail hereinafter.

### [Description of Configuration of Electrode Assembly A700]

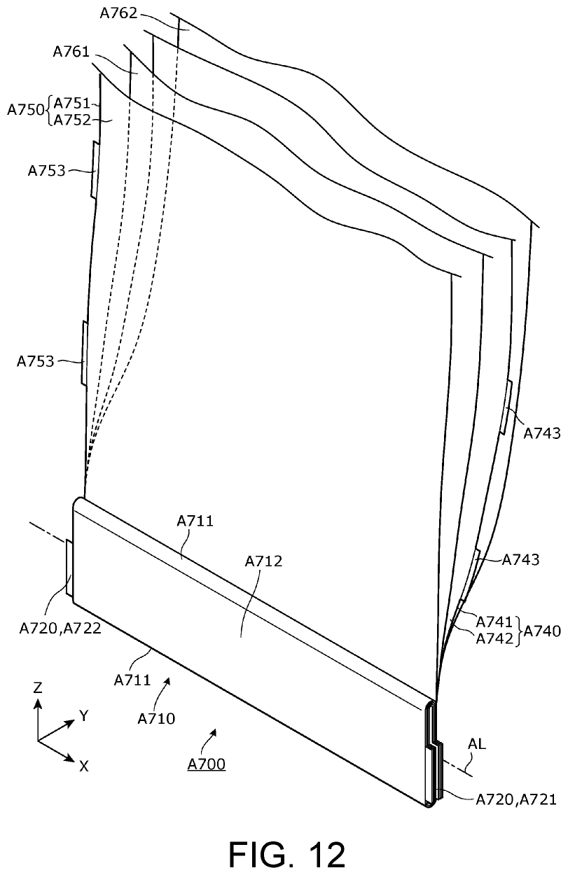

FIG. 12 is a perspective view illustrating the configuration of the electrode assembly A700 according to the embodiment 2. Specifically, FIG. 12 illustrates the winding state of the plates in the electrode assembly A700 in a state where the winding state of the plates is partially developed. As illustrated in FIG. 12, the electrode assembly A700 includes a positive plate A740, a negative plate A750, and separators A761, A762.

The positive plate A740 is a plate (an electrode plate) that is formed such that a positive active material layer A742 is formed on a surface of the positive electrode substrate A741 that is an elongated strip-shaped metal foil made of aluminum or an aluminum alloy. The negative plate A750 is a plate (an electrode plate) that is formed such that a negative active material layer A752 is formed on a surface of the negative electrode substrate A751 that is an elongated strip-shaped metal foil made of copper or a copper alloy. As the positive electrode substrate A741 and the negative electrode substrate A751, known materials such as nickel, iron, stainless steel, titanium, baked carbon, a conductive polymer, a conductive glass, and an Al—Cd alloy can be appropriately used provided that the materials are stable to the oxidation-reduction reaction during charging and discharging. As a positive active material used for forming the positive active material layer A742 and a negative active material used for forming the negative active material layer A752, known materials can be appropriately used provided that the materials are a positive active material and a negative active material capable of occluding and discharging lithium ions.

For example, as the positive active material, a polyanion compound such as LiMPO₄, LiMSiO₄, or LiMBO₃ (M representing one kind or two or more kinds of transition metal elements selected from Fe, Ni, Mn, Co, and the like), lithium titanate, a spinel-type lithium manganese oxide such as LiMn₂O₄ or LiMn_{1.5}Ni_{0.5}O₄, a lithium transition metal oxide such as LiMO₂ (M representing one kind or two or more kinds of transition metal elements selected from Fe, Ni, Mn, Co, and the like), or the like can be used. As the negative active material, besides lithium metal and a lithium alloy (lithium metal-containing alloys such as lithium-silicon, lithium-aluminum, lithium-lead, lithium-tin, lithium-aluminum-tin, lithium-gallium, and a wood's alloy), an alloy capable of occluding and releasing lithium, a carbon material (for example, graphite, non-graphitizable carbon, graphitizable carbon, low-temperature calcined carbon, amorphous carbon, and the like), a silicon oxide, a metal oxide, a lithium metal oxide (Li₄Ti₅O₁₂ or the like), a polyphosphoric acid compound, and a compound of transition metal and an element belong to any one of groups 14 to 16, such as Co₃O₄ or Fe₂P, that is generally referred to as a conversion negative electrode can be named.

The separators A761, A762 are each formed of a microporous sheet made of a resin. As a material of the separators A761 and A762, a known material can be suitably used provided that the performance of the energy storage device A10 is not impaired by the separators A761, A762. For example, as the separators A761 and A762, a woven fabric, a nonwoven fabric, a synthetic resin microporous membrane made of a polyolefin resin such as polyethylene, or the like all of which are insoluble by an organic solvent can be used.

The electrode assembly A700 is formed by alternately stacking and winding the positive plate A740, the negative plate A750, and the separators A761, A762. That is, the electrode assembly A700 is formed by stacking and winding the negative plate A750, the separator A761, the positive plate A740, and the separator A762 in this order. In the present embodiment, the electrode assembly A700 is a winding-type electrode assembly that is formed by winding the positive plate A740, the negative plate A750 and the like around the winding axis AL extending in the X-axis direction. The winding axis AL is a virtual axis that becomes a central axis when the positive plate A740, the negative plate A750 and the like are wound, and in the present embodiment, the winding axis AL is a straight line which passes through the center of the electrode assembly A700 and is parallel to the X-axis direction.

On the one end edge (end edge in the X-axis positive direction) of the positive plate A740 in the winding axis direction, a plurality of protruding members A743 respectively protruding outward are disposed at predetermined intervals. In the same manner, on the other end edge (end edge in the X-axis negative direction) of the negative plate A750 in the winding axis direction, a plurality of protruding members A753 respectively protruding outward are disposed at predetermined intervals. Each of the protruding members A743 and A753 is a portion where the active material layer containing the active material is not formed and the substrate layer is exposed (an active material layer-non-formed portion).

When the positive plate A740, the negative plate A750, and the separators A761 and A762 are wound, the respective protruding members A743 of the positive plate A740 overlap with each other on one end surface of the body portion A710, and the respective protruding members A753 of the negative plate A750 overlap with each other on the other end surface of the body portion A710. A portion where the respective protruding members A743 of the positive plate A740 overlap with each other forms the positive electrode connecting portion portion 721. That is, the positive electrode connecting portion A721 is a portion formed by stacking a plurality of members (the protruding members A743) of the plates having the same polarity (the positive plates A740) out of the plurality of plates (the positive plates A740 and the negative plates A750).

In the same manner, a portion where the respective protruding members A753 of the negative plates A750 overlap with each other forms the negative electrode connecting portion A722. That is, the negative electrode connecting portion A722 is a portion formed by stacking a plurality of members (protruding members A753) of the plates having the same polarity (the negative plates A750) out of the plurality of plates (the positive plates A740 and the negative plates A750).

As described above, the electrode assembly A700 includes: the body portion A710 that forms the main body of the electrode assembly A700; and the plurality of connecting portions A720 (the positive electrode connecting portion A721 and the negative electrode connecting portion A722) that respectively protrude from both end surfaces of the body portion A710 in the X-axis direction.

The body portion A710 is an elongated circular columnar portion (an active material layer forming portion) formed by winding portions of the positive plate A740 and the negative plate A750 where the positive active material layer A742 and the negative active material layer A752 are formed (coated) and the separators A761 and A762. With such a configuration, the body portion A710 has a pair of curved portions A711 on both sides in the Z-axis direction, and has a flat portion A712 having a flat shape as a whole between the pair of curved portions A711. It can also be said that the pair of curved portions A711 is disposed at positions where the pair of curved portions A711 interpose the flat portion A712 therebetween in the Z-axis direction.

The curved portions A711 are curved portions that are curved in a semicircular arc shape so as to protrude in the Z-axis direction as viewed in the X-axis direction, extend in the X-axis direction and are disposed so as to face the bottom wall portion of the container body A160 and the top wall portion of the lid body A170. In other words, the pair of curved portions A711 is portions curved so as to protrude from the flat portion A712 toward the bottom wall portion of the container body A160 and the top wall portion of the lid body A170 as viewed in the X-axis direction, that is, toward both sides of the electrode assembly A700 in the Z-axis direction.

The flat portions A712 are each a rectangular and flat portion that connects the end portions of the pair of curved portions A711 to each other and extends parallel to the XZ plane directed in the Y-axis direction. The flat portions A712 are disposed so as to face the long-side wall portions of the container body A160 on both sides in the Y-axis direction. The flat portions A712 are main portions of the electrode assembly A700. In the flat portion A712, a plurality of wound plates (the positive plates A740 and the negative plates A750) are stacked in the Y-axis direction. That is, in the flat portion A712, the Y-axis direction is a direction that the plurality of plates are stacked with each other. As described above, since the flat portion A712 is the main portion of the electrode assembly A700 and hence, in the present disclosure, the main stacking direction of the electrode assembly A700 is defined as the Y-axis direction.

The curved shape of the curved portion A711 is not limited to a semicircular arc shape, and may be a part of an elliptical shape or the like, and may be curved in any shape. An outer surface of the flat portion A712 that is directed in the Y-axis direction is not limited to a flat surface. That is, the outer surface may be slightly recessed or may be slightly bulged.

### [Positional Relationship Between Terminal Body Portion, Recessed Portion, Electrode Assembly, and Current Collector]

Next, the positional relationship between the terminal body portion A330, the recessed portion A101, the electrode assembly A700, and the current collector A600 will be described. In the present embodiment, the explanation is made by illustrating the first side surface portion A110 as an example. However, the second side surface portion A120 has substantially the same configuration and hence, the explanation of the second side surface portion A120 is omitted.

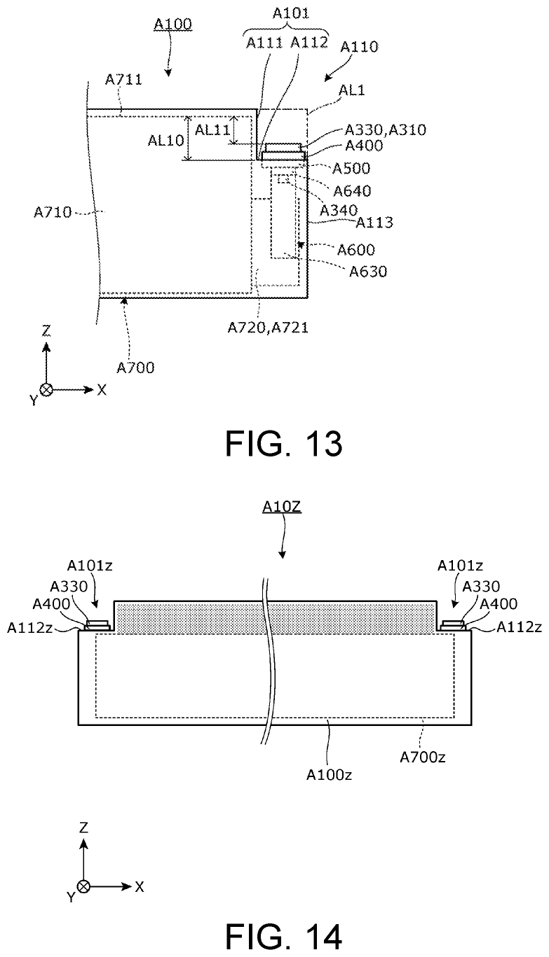

FIG. 13 is a plan view illustrating the first side surface portion A110 according to the embodiment 2. In FIG. 13, the internal structure of the container A100 is indicated by a broken line. Also in FIG. 13, a rectangular parallelepiped shape of the container A100 that is used as a reference is indicated by a double-dashed chain line AL1. Accordingly, the “inside of the recessed portion A101” means the inside of a region that is defined by a profile having a rectangular parallelepiped shape (double-dashed chain line AL1) that is used as the reference, the first upper side surface A111, and the first upper surface A112.

As illustrated in FIG. 13, in the recessed portion A101, the terminal body portion A330 of the positive electrode terminal A310 is mounted on the first upper surface A112 that forms the terminal mounting surface in a protruding manner outward through the outer gasket A400. Specifically, the terminal body portion A330 protrudes from the first upper surface A112 in a direction (Z-axis direction) that intersects with the stacking direction (Y-axis direction) of the electrode assembly A700. In this state, the entirety of the terminal body portion A330 of the positive electrode terminal A310 is accommodated in the recessed portion A101 as viewed in the Y-axis direction. That is, the terminal body portion A330 of the positive electrode terminal A310 is disposed below the top surface A140 as a whole.

In the first side surface portion A110, the positive electrode connecting portion A721 of the electrode assembly A700 is disposed below the recessed portion A101. That is, as viewed in a plan view of the first upper surface A112 that is the terminal mounting surface, the positive electrode connecting portion A721 is disposed in a space that overlaps with the first upper surface A112. With such a configuration, the positive electrode connecting portion A721 is disposed at a position where the positive electrode connecting portion A721 is retracted from the portion that forms the first upper side surface A111 and hence, the body portion A710 of the electrode assembly A700 can be disposed close to the portion that forms the first upper side surface A111. Accordingly, it is possible to form the body portion A710 that is a portion contributing to storage of energy (generation power) as large as possible.

The current collector A600 extends in the Z-axis direction in a space that overlaps with the first upper surface A112 when the first upper surface A112 that forms the terminal mounting surface is viewed in a plan view. Specifically, the first joint portion A630 of the current collector A600 is a plate-like portion that extends in the Z-axis direction, and is joined to the positive electrode connecting portion A721. The second joint portion A640 of the current collector A600 is a plate-like portion bent from an upper end of the first joint portion A630, and is joined to the shaft portion A340 of the positive electrode terminal A310. The first joint portion A630 and the second joint portion A640 are accommodated in a space that overlaps with the first upper surface A112 when the first upper surface A112 is viewed in a plan view. That is, the first joint portion A630 and the positive electrode tab portion 721 are joined to each other in the space in a state where the current collector A600 does not protrude from the space, and also the joining structure of these constitutional elements does not protrude from the space.

An upper end portion (a curved portion A711 in the Z-axis positive direction) of the body portion A710 of electrode assembly A700 is disposed above first upper surface A112. More specifically, the upper end portion of the body portion A710 is disposed above the terminal body portion A330. In other words, the distal end portion of the body portion A710 in the protruding direction of the terminal body portion A330 (the curved portion A711 in the Z-axis positive direction) protrudes more than the distal end portion of the terminal body portion A330. That is, as illustrated in FIG. 13, the distal end portion of the body portion A710 protrudes from the terminal body portion A330 by a length L10. Further, it can also be said that the distal end portion of the body portion A710 protrudes from the distal end surface of the positive electrode terminal A310 by a length L11 (<L10).

FIG. 14 is a plan view schematically illustrating an energy storage device A10Z according to a comparative example. In the energy storage device A10Z illustrated in FIG. 14, an upper end portion of an electrode assembly A700z is disposed below a first upper surface A112z that forms a terminal mounting surface. Therefore, in a container A100z, a space between a pair of recessed portions A101z forms a surplus space (a portion indicated by dotted hatching in FIG. 14).

On the other hand, in the present embodiment, the upper end portion of the body portion A710 of the electrode assembly A700 is disposed above the terminal body portion A330 and hence, the body portion A710 can be disposed in the surplus space described above. As a result, the surplus space in the container A100 is reduced.

### [Description of Advantageous Effects of Embodiment 2]

As has been described above, in the energy storage device A10 according to the embodiment 2, the distal end portion of the body portion A710 of the electrode assembly A700 protrudes with respect to the first upper surfaces A112 (terminal mounting surfaces) of the container A100 and hence, the body portion A710 can be disposed in the surplus space formed between the terminal body portions A330 of the pair of electrode terminals A300. As a result, the surplus space in the container A100 can be reduced. Accordingly, it is possible to suppress the lowering of the space utilization efficiency of the energy storage device A10. Therefore, the electric capacitance of the energy storage device A10 can be also increased. In the present embodiment, the space utilization efficiency means the degree of effective use of the space in the energy storage device A10, it may be expressed that, when the surplus space is large, the degree of effective use is low and hence, the space utilization efficiency is also lowered.

Even in a case where the distal end portion of the body portion A710 is coplanar with the first upper surfaces A112 (terminal mounting surfaces) of the container A100, the distal end portion of the body portion A710 is disposed in the surplus space and hence, it is possible to suppress the lowering of the space utilization efficiency of the energy storage device A10 to some extent. In such a configuration, the term “coplanar” also includes a state where a top point of the curved portion A711 in the Z-axis positive direction that is the distal end portion of the body portion A710 and the first upper surfaces A112 that are the terminal mounting surfaces are at the same height position.

To the contrary, in the present embodiment, the distal end portion of the body portion A710 of the electrode assembly A700 protrudes more than the distal end portions of the terminal body portions A330. Accordingly, the body portion A710 can be disposed with a larger size in the surplus space formed between the terminal body portions A330 of the pair of electrode terminals A300. With such a configuration, it is possible to further suppress the lowering of the space utilization efficiency of the energy storage device A10 and hence, it is also possible to further increase the electric capacitance of the energy storage device A10.

A first joint portion A630a of the current collector A600 and a second joint portion A640a of the current collector A600 are accommodated in a space that overlaps with the first upper surface A112 when the first upper surface A112 is viewed in a plan view. That is, the first joint portion A630 and the positive electrode connecting portion A721 are joined to each other in the space in a state where the current collector A600 does not protrude from the space, and also the joining structure of these constitutional elements does not protrude from the space. With such a configuration, even when the body portion A710 of the electrode assembly A700 is disposed as large as possible, the current collector A600 and the positive electrode connecting portion A721 can be easily joined to each other.

Each of the positive electrode connecting portion A721 and the negative electrode connecting portion A722 is disposed in a space that overlaps with the terminal mounting surface (the first upper surface A112, the second upper surface A122) when the terminal mounting surface is viewed in a plan view. Accordingly, the body portion A710 of the electrode assembly A700 can be formed as large as possible between the pair of terminal mounting surfaces of the container A100. The body portion A710 of the electrode assembly A700 is a portion that contributes to the storage of energy (generation of power) and hence, the electric capacitance can be increased by forming the portion largely.

### [Description of Modification of Embodiment 2]

Next, respective modifications of the above-mentioned embodiment 2 will be described. In the following description, components equivalent to the components in the above-mentioned embodiment 2 or other modifications are denoted by the same reference numerals, and the description of these components may be omitted. In the following description, the first side surface portion will be described as an example. However, the second side surface portion also has substantially the same shape as the first side surface portion.

### Modification 1 of Embodiment 2

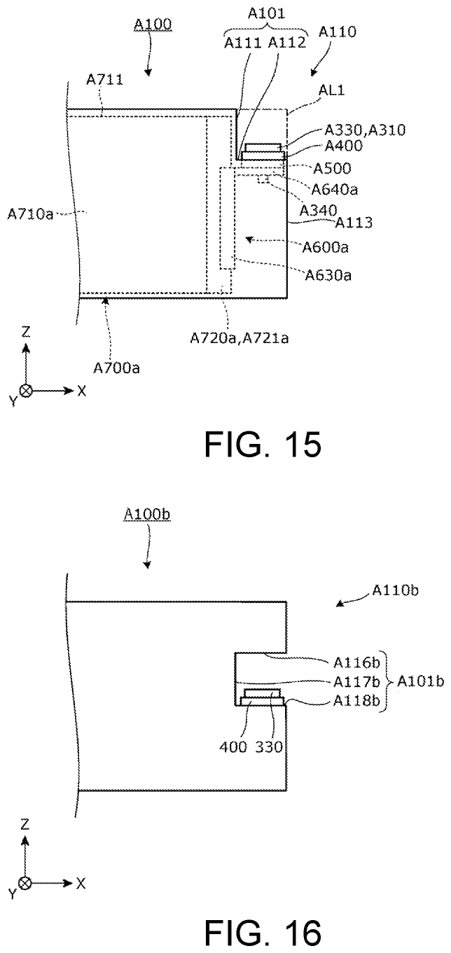

Next, a modification 1 of the above-mentioned embodiment 2 will be described. FIG. 15 is a plan view illustrating a first side surface portion A110a according the modification 1 of the embodiment 2. In the embodiment 2 described above, the electrode assembly A700 is exemplified where the connecting portion A720 is formed on a part of the body portion A710 in the Z-axis direction. In the modification 1, the description is made by exemplifying an electrode assembly A700a where a connecting portion A720a is disposed over the entirety of the body portion A710a in the Z-axis direction.

Specifically, as illustrated in FIG. 15, in the electrode assembly A700a, a positive electrode connecting portion A721a protrudes in the X-axis positive direction from the entirety of an electrode assembly body 710a in the Z-axis direction. Accordingly, the body portion A710a is disposed so as to be positioned more in the X-axis negative direction than a recessed portion A101.

A first joint portion A630a of a current collector A600a is joined to a positive electrode connecting portion A721a. A second joint portion A640a of the current collector A600a is bent from an upper end of the first joint portion A630a in a direction (an X-axis positive direction) away from the body portion A710, and is joined to a shaft portion A340 of a positive electrode terminal A310. As described above, the second joint portion A640 of the current collector A600 is bent with respect to the first joint portion A630 in a direction away from the body portion A710 and hence, the second joint portion A640 can be easily joined to the electrode terminal A300 disposed outside the body portion A710.

### Modification 2 of Embodiment 2

Next, a modification 2 of the above-mentioned embodiment 2 will be described. FIG. 16 is a plan view illustrating a first side surface portion A110b according to the modification 2 of the embodiment 2. As illustrated in FIG. 16, in the first side surface portion A110b according to the modification 2, a first recessed portion A101b is formed at an intermediate portion in the Z-axis direction. The first recessed portion A101b is a rectangular cutout where only an end in the X-axis positive direction is opened. The first recessed portion A101b has: an inner top surface A116b that forms a top surface of the first recessed portion A101b; an inner side surface A117b that is formed continuously with the inner top surface A116b and forms a side surface of the first recessed portion A101b; and an inner bottom surface A118b that is formed continuously with the inner side surface A117b and forms a bottom surface of the first recessed portion A101b. FIG. 16 illustrates a case where the inner bottom surface A118b forms a terminal mounting surface, and a terminal body portion 330 is mounted on the inner bottom surface A118b by way of the outer gasket 400. The inner top surface A116b or the inner side surface A117b may be used as a terminal mounting surface.

As described above, also in a container A100b according to the modification 2 of the embodiment 2, the terminal body portion 330 does not protrude from an upper portion of a container A100b and hence, it is possible to reduce a surplus space formed in an upper portion of the container A100b.

### Modification 3 of Embodiment 2

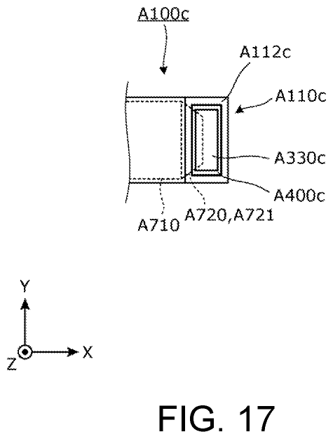

Next, a modification 3 of the above-mentioned embodiment 2 will be described. FIG. 17 is a top plan view illustrating a first side surface portion A110c according to the modification 3 of the embodiment 2. In the embodiment 2 described above, the case is exemplified where the first upper surface A112 is elongated in the X-axis direction (predetermined direction). In the modification 2, a case is exemplified where a first upper surface A112c is elongated in the Y-axis direction (the stacking direction).

As illustrated in FIG. 17, the first upper surface A112c is formed in a rectangular shape where a length in the Y-axis direction is longer than a length in the X-axis direction. An outer gasket A400c and a terminal body portion A330c are shaped so as to be accommodated in the first upper surface A112c. Specifically, both the outer gasket A400c and the terminal body portion A330c are formed in a rectangular shape where a length in the Y-axis direction is longer than a length in the X-axis direction.

A case is considered where an electrode assembly A700 has the structure where an upper end portion of a body portion A710 is coplanar with or protrudes from the first upper surface A112c (terminal mounting surface). In this case, it is necessary to position the terminal mounting surface more in the X-axis positive direction than the body portion A710. In this case, there is also a demand that a size of the terminal mounting surface should be made as small as possible in order to suppress the large-sizing of a container A100c. To satisfy such a demand, as described above, by forming the first upper surface A112c, that is, the terminal mounting surface in a shape where the length in the Y-axis direction (stacking direction) is longer than the length in the X-axis direction (predetermined direction), the size of the terminal body portion A330c can be made as large as possible within the terminal mounting surface. With such a configuration, a joint area between the conductive member such as a bus bar and a terminal body portion A330c can be made as large as possible.

### Embodiment 3

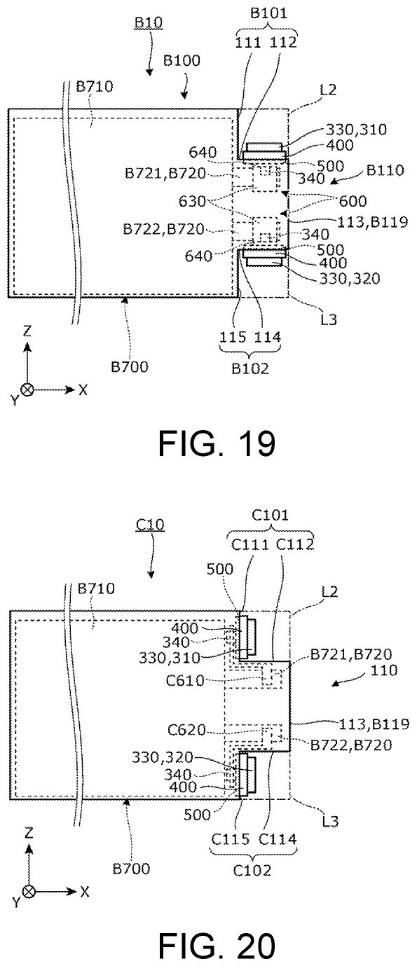

An energy storage device B10 according to an embodiment 3 is described with reference to FIG. 19. FIG. 19 is a schematic plan view illustrating the energy storage device B10 according to the embodiment 3. In the energy storage device 10 according to the embodiment 1 described above, the case is exemplified where the protruding portions 119 are provided to both end portions of the container 100 in the X-axis direction. In the embodiment 3, a case is exemplified where a protruding portion is provided to only one end portion of the container in the X-axis direction. In the following description, components equivalent to the components in the embodiment 1 are denoted by the same reference numerals, and the description of these components may be omitted.

As illustrated in FIG. 19, in a container B100 of the energy storage device B10, a first protruding portion B119 is formed on a first side surface portion B110. Specifically, in the first side surface portion B110, a portion interposed between a first recessed portion B101 and a second recessed portion B102 in the Z-axis direction forms the protruding portion B119. On the other hand, an end portion of the container B100 in the X-axis negative direction is formed in a flat shape as a whole. Specifically, an end portion of the container B100 in the X-axis negative direction is a flat surface parallel to the YZ plane extending from an end portion in the Z-axis positive direction to an end portion in the Z-axis negative direction.

In the electrode assembly B700 accommodated in the container B100, a pair of tab portions B720 are formed on only one end portion of the electrode assembly B700 in the winding axis direction. Specifically, on one end surface of the body portion B710 of the electrode assembly 700B in the X-axis direction, positive electrode tab portions B721 are formed at a predetermined interval from an end portion in the Z-axis positive direction, and negative electrode tab portions B722 are formed at a predetermined interval from an end portion in the Z-axis negative direction. The positive electrode tab portions B721 and the negative electrode tab portions B722 are disposed in the protruding portion B119 of the container B100.

On the other hand, tab portions do not protrude from the other end surface of the body portion B710 of the electrode assembly 700B in the X-axis direction. Accordingly, the body portion B710 can be disposed as close as possible to the end portion of the container B100 in the X-axis negative direction.

With respect to this embodiment 3, to compare the container 100 where the protruding portion 119 is formed at both end portions in the winding axis direction as in the case of the embodiment 1 and the container B100 where the protruding portion B119 is formed at one end portion and the other end portion is formed in a flat shape with each other, provided that the length of the container in the winding axis direction is the same with respect to both containers, the latter container can make the space other than the protruding portion B119 larger than the former container. That is, in the case of the container B100 where the protruding portion B119 is formed at one end portion and the other end portion is formed in a flat shape, the body portion B710 (electrode assembly body) can be made larger. Accordingly, it is possible to increase the energy density.

### Modification 1 of Embodiment 3

An energy storage device C10 according to a modification 1 of the embodiment 3 will be described with reference to FIG. 20. FIG. 20 is a schematic plan view illustrating the energy storage device C10 according to the modification 1 of the embodiment 3. In the following description, components equivalent to the components in the embodiment 3 are denoted by the same reference numerals, and the description of these components may be omitted.

As illustrated in FIG. 20, in a first recessed portion C101 of the energy storage device C10, the positive electrode terminal 310 is not disposed on a first upper surface C112, and a positive electrode terminal 310 is disposed on a first upper side surface C111. That is, the first upper side surface C111 forms a terminal mounting surface. Specifically, in the first recessed portion C101, a terminal body portion 330 of the positive electrode terminal 310 protrudes outward by way of an outer gasket 400 on the first upper side surface C111 that forms the terminal mounting surface. In this state, the entirety of the terminal body portion 330 of the positive electrode terminal 310 is accommodated in the first recessed portion C101 as viewed in the Y-axis direction. A positive electrode current collector C610 is joined to a shaft portion 340 of the positive electrode terminal 310. The positive electrode current collector C610 is bent so as to be away from the first recessed portion C101, and is joined to a positive electrode tab portion B721.

In a second recessed portion C102, a negative electrode terminal 320 is not disposed on a first lower surface C114, and the negative electrode terminal 320 is disposed on a first lower side surface C115. That is, the first lower side surface C115 forms the terminal mounting surface. Specifically, in a second recessed portion C102, the terminal body portion 330 of the negative electrode terminal 320 protrudes outward by way of the outer gasket 400 on the first lower side surface C115 that forms the terminal mounting surface. In this state, the entirety of the terminal body portion 330 of the negative electrode terminal 320 is accommodated in the second recessed portion C102 as viewed in the Y-axis direction. A negative electrode current collector C620 is joined to the shaft portion 340 of the negative electrode terminal 320. The negative electrode current collector C620 is bent so as to be away from the second recessed portion C102, and is joined to the negative electrode tab portion B722.

### Modification 2 of Embodiment 3

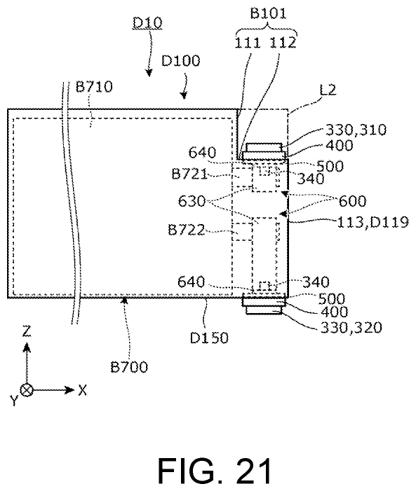

An energy storage device D10 according to a modification 2 of the embodiment 3 will be described with reference to FIG. 21. FIG. 21 is a schematic plan view illustrating the energy storage device D10 according to the modification 2 of the embodiment 3. In the following description, components equivalent to the components in the embodiment 3 are denoted by the same reference numerals, and the description of these components may be omitted.

As illustrated in FIG. 21, a container D100 of the energy storage device D10 has a first recessed portion B101. However, the container D100 does not have a second recessed portion. Therefore, a negative electrode terminal 320 is disposed on a bottom surface D150 of the container D100. In this case, a portion of the container D100 arranged adjacently to the first recessed portion B101 in the Z-axis direction forms a protruding portion D119. That is, the protruding portion D119 is a portion that protrudes more in the X-axis positive direction than a first upper side surface 111 of the first recessed portion B101. A positive electrode tab portion B721 and a negative electrode tab portion B722 are disposed in the protruding portion D119 of the container D100.

### Other Modifications

Although the energy storage devices according to the embodiments of the present invention (including the modifications of the embodiments have been described, the same understanding being adopted in the description made hereinafter) have been described heretofore, the present invention is not limited to the respective embodiments and modifications described above. The embodiments disclosed in this specification are illustrative in all aspects, and the present invention includes all alterations which fall within the scope of claims or are considered equivalent to the present invention called for in claims.

For example, in the embodiment 1 and the like described above, the case where only one electrode assembly 700 is accommodated in the container 100 has been exemplified. However, a plurality of electrode assemblies may be accommodated in the container.

In the embodiment 1 and the like described above, the case is exemplified where the positive electrode tab portion 721 and the negative electrode tab portion 722 are disposed in a reversed manner (vertically upside down) as viewed in the X-axis direction on one end surface and the other end surface of the body portion 710 of the electrode assembly 700. However, the positive electrode tab portion 721 and the negative electrode tab portion 722 may not be disposed in a reversed manner. At least only one positive electrode tab portion 721 may be mounted on one end surface of the electrode assembly, and at least only one negative electrode tab portion 722 may be mounted on the other end surface of the electrode assembly.

In the embodiment 1 and the like described above, the winding-type electrode assembly 700 has been exemplified. However, the type of the electrode assembly is not limited to the winding type, and a stacking type electrode assembly where flat plate-shaped plates are stacked, an electrode assembly where plates and/or separators are folded in a bellows shape (a mode where the separator is folded in a bellows shape so as to interpose plates having a rectangular shape, a mode where the plates and the separators are made to overlap with each other and, thereafter, these plates and the separators are folded in a bellows shape and the like), or the like may be adopted. In all cases, it is sufficient that the stacking direction of the electrode assembly be set to the Y-axis direction. For example, even in the case of a non-winding-type electrode assembly such as a stacking type electrode assembly, a profile of the electrode assembly is formed in a shape that corresponds to the profile of the electrode assembly 700 illustrated in FIG. 4. In this case, an upper end portion and the other end portion of the non-winding type electrode assembly have a planar shape.

In the above-mentioned embodiment 1 and the like, the case is exemplified where the first recessed portion 101 is disposed at the same position in the first side surface portion 110 and the second side surface portion 120. However, the first recessed portion 101 may be disposed at different positions between the first side surface portion 110 and the second side surface portion 120. The first recessed portion 101 may be formed only in one of the first side surface portion 110 and the second side surface portion 120.

The configurations that are formed by arbitrarily combining the respective constituent elements that the embodiments and the modification examples described above include also fall within the scope of the present invention.

### INDUSTRIAL APPLICABILITY

The present invention is applicable to an energy storage device such as a lithium ion secondary battery or the like.

### DESCRIPTION OF REFERENCE SIGNS

10, A10, 10Z, A10Z, B10, C10, D10: energy storage device
100, 100a, 100c, 100z, A100, A100b, A100c, A100z, B100, D100: container
101, 101a, 101c, A101b, B101, C101: first recessed portion (recessed portion)
A101, A101b, A101z: recessed portion
102, 102a, B102, C102: second recessed portion (recessed portion)
110, 110a, 110c, 110d, A110, A110a, A110b, A110c: first side surface portion (side surface portion)
111, A111: first upper side surface
C111: first upper side surface (terminal mounting surface)
112, 112d, A112, A112c, A112z: first upper surface (terminal mounting surface)
113: first intermediate side surface
114: first lower surface (terminal mounting surface)
A114b: first lower surface
115, A115b: first lower side surface
C115: first lower side surface (terminal mounting surface)
119, B119, D119: protruding portion
120, A120: second side surface portion (side surface portion)
121, A121: second upper side surface
122, A122: second upper surface (terminal mounting surface)
123: second intermediate side surface
A123: second side surface
124: second lower surface (terminal mounting surface)
125: second lower side surface
130, A130: long side surface
140, 140a, 140z, A140: top surface
150, 150a, 150z, A150, D150: bottom surface
160, A160: container body
170, A170: lid body
300, A300, A300b: electrode terminal (terminal)
330, A330, A330b, A330c: terminal body portion
340, A340: shaft portion
600, A600, A600a: current collector
630, A630, A630a: first joint portion
640, A640, A640a: second joint portion
700, A700, A700a, A700z, B700: electrode assembly
710, A710, A710a, B710: body portion (electrode assembly body)
720, A720, A720a, B720: connecting portion
740, A740: positive plate (plate)
750, A750: negative plate (plate)
900: bus bar
910: wire
Sd: space

1. An energy storage device comprising:
an electrode assembly that is formed by stacking a plurality of plates and is elongated in a predetermined direction intersecting with a stacking direction;
a container that accommodates the electrode assembly and is elongated in the predetermined direction; and
a positive electrode terminal and a negative electrode terminal that are electrically connected to the electrode assembly, wherein
the electrode assembly includes:
an electrode assembly body; and
a pair of connecting portions that protrudes from one end portion of the electrode assembly body in the predetermined direction, and is electrically connected to the positive electrode terminal and the negative electrode terminal, and
a protruding portion on which the pair of connecting portions is disposed is formed at one end portion of the container in the predetermined direction.

2. The energy storage device according to claim 1, wherein an other end portion of the container in the predetermined direction is formed in a flat shape.

3. The energy storage device according to claim 1, wherein a pair of recessed portions that interposes the protruding portion is formed on the one end portion of the container,
the positive electrode terminal is disposed in one recessed portion out of the pair of recessed portions, and the negative electrode terminal is disposed in an other recessed portion out of the pair of recessed portions.

4. The energy storage device according to claim 3, wherein the protruding portion includes a pair of terminal mounting surfaces that opposedly faces each other in an arrangement direction of the pair of connecting portions,
the positive electrode terminal is disposed on one terminal mounting surface out of the pair of terminal mounting surfaces, and the negative electrode terminal is disposed on an other terminal mounting surface out of the pair of terminal mounting surfaces.

5. The energy storage device according to claim 1, wherein the electrode assembly includes a pair of an other connecting portions that protrudes from an other end portion in the predetermined direction and is electrically connected to an other positive electrode terminal and an other negative electrode terminal, and
an other protruding portion on which the pair of the other connecting portions is disposed is formed on an other end portion of the container in the predetermined direction.

6. The energy storage device according to claim 1, wherein the electrode assembly is configured such that the plurality of plates are wound using the predetermined direction as a winding axis direction.
